(19) United States
(12) Patent Application Publication
(10) Pub. No.: US 2019/0092212 A1
(43) Pub. Date: Mar. 28, 2019

(54) SLIDABLE ROOM ASSEMBLIES

(71) Applicant: NORCO INDUSTRIES, INC., Compton, CA (US)

(72) Inventors: Bernard F. GARCEAU, Vandalia, MI (US); Bori KROBOT, LaPorte, IN (US)

(21) Appl. No.: 16/136,528

(22) Filed: Sep. 20, 2018

Related U.S. Application Data
(60) Provisional application No. 62/562,084, filed on Sep. 22, 2017.

(51) Int. Cl. B60P 3/34; F16H 19/06; B66D 1/20

(52) U.S. Cl. CPC B60P 3/34; B66D 1/20; F16H 19/06

(57) ABSTRACT

A slide-out unit assembly that includes a vehicle body having an opening formed in an exterior wall and a reciprocable slide-out unit (e.g., room or compartment) disposed in the opening and slidable between a retracted position and an extended position. Sliding movement of the slide-out unit is controlled by a drive assembly that includes a sprocket that drives a drive chain assembly connected to the slide-out unit as described herein. Sliding movement of the slide-out unit may be either motor-driven or manually powered.

### CROSS-REFERENCE TO RELATED APPLICATION

This patent application claims priority to and the benefit of pending provisional patent application 62/562,084 filed on Sep. 22, 2017, which is incorporated by reference herein in its entirety.

### TECHNICAL FIELD

The disclosures herein relate in general to slidable room assemblies. More particularly, aspects herein relate to slidable room assemblies installed within vehicle jambs.

### BACKGROUND

The present subject matter relates to a slidable room assembly, particularly to a slidable room assembly for a vehicle having a slide-out room or compartment that is retracted when the vehicle is in motion and may be extended to afford more room when the vehicle is parked. More particularly, this subject matter relates to a slidable room assembly that includes an improved mechanism for reciprocation of the slide-out unit relative to the vehicle.

Recreational vehicles, including motor homes, fifth wheel trailers and travel trailers may be provided with an extendible slide-out unit for increasing the vehicle's living space. This slide-out unit may be extended for use when the vehicle is parked and is retracted in a telescoping manner when the vehicle is to be moved.

Prior vehicle slide-out installations that include an extension/retraction system that relies on screws or a pinion for effecting telescoping movement of the slide-out unit relative to the vehicle are known. Screws, in particular, must be short for practical reasons, including the tendency of a longer screw to deflect so that the axis of the screw is not absolutely straight. This, of course, greatly impairs operability of the screw. Pinions must also be comparatively short for practical reasons, including excessive weight in a pinion of greater length. Since the amplitude of movement of the slide-out room or compartment can be no greater than the length of the screw or pinion, the amplitude of sliding movement, and hence the amount of additional space gained by the slide-out compartment, is limited.

Other types of slide-out installations for vehicles are also known. One such installation employs an endless cable that passes over one pair of pulleys supported by a main part of a mobile home and a second pair of pulleys mounted on sidewalls of an extension part of the mobile home to cause the extension part to reciprocate. Another slide-out installation shows an expanding caravan, which also includes a rotatable shaft and two types of cables wound there around. Rotation of the shaft in one direction causes one type of cable to wind as the other type unwinds, causing a sliding unit to reciprocate in one direction (say outwardly) relative to the vehicle. Rotation of the shaft in the opposite direction causes the sliding unit to move in the opposite direction (say inwardly relative to the vehicle).

A challenge with slidable room assemblies is that a slide-out room is cantilevered as it is extended. The outer end of the extended slide-out room tends to tip downwardly. This puts weight on the slide-out unit's operating mechanism. The cantilevered slide-out room also tends to be loose at the top and tight at the bottom. This puts weight on the slide-out mechanism, which, in turn, impairs slidability and also invites leakage.

Another challenge with presently known slide-out units is that they require modification of the vehicle's underframe, unless the slide-out unit is of small size. For example, it may sometimes be necessary to cut away a portion of the underframe in order to accommodate the operating mechanism of the slide-out unit. This impairs the ability of the underframe to support the vehicle by lessening the strength and rigidity of the underframe.

### SUMMARY

The embodiments described herein include a slidable room assembly in a vehicle body having a plurality of exterior walls, at least one of which has an opening, and a slide-out unit insertable within the opening and reciprocable between an extended position and a retracted position, the slide-out unit having a pair of opposing sidewalls. In such embodiments, the slidable room assembly may comprise a pair of first drive chains that are each respectively attached to the opposing sidewalls of the slide-out unit and a pair of jamb members that are each respectively arranged within the opening proximate to the opposing sidewalls of the slide-out unit, where each of the jamb members includes a drive shaft arranged within a channel of the jamb member and a drive sprocket that is arranged on an end of the drive shaft and configured to engage one of the pair of first drive chains, wherein the drive sprockets rotate with the drive shafts to engage the pair of first drive chains and thereby move the slide-out unit between the extended position and the retracted position.

In some embodiments, the slidable room assembly includes a motor coupled to one of the drive shafts within one of the jamb members and, in such other embodiments, the slidable room assembly may further include a timing shaft that couples the drive shafts together, wherein a first of the drive shafts that is associated with a first of the opposing side walls of the slide-out unit rotates in unison with a second of the pair of drive shafts that is associated with a second of the opposing side walls of the slide-out unit. In other embodiments, the slidable room assembly includes a pair of motors, wherein a first of the pair of jamb members includes a first of the motors coupled to a first of the pair of drive shafts, and wherein a second of the pair of jamb members includes a second of the motors coupled to a second of the pair of drive shafts. In these other embodiments, the slidable room assembly further includes a timing shaft that couples the drive shafts together such that they rotate in unison.

Embodiments described herein may also include a slidable room assembly, wherein each of the first drive chains is arranged within a channel member that is secured to each of the opposing sidewalls of the slide-out unit. In some embodiments, the channel members may include a pair of channel member sidewalls and a rail that together define a chain channel, and the first drive chain is arranged within the chain channel. In these embodiments, the channel members may further include an interior channel defined by the channel member sidewalls and the rail, wherein the rail interposes the interior channel and the chain channel. Additionally, in these embodiments, each of the first drive chains may include a first chain end and a second chain end; the first chain end and the second chain end extending beyond a respective first rail end and second rail end of the chain rail when the first drive chains are arranged within the chain channel, and wherein the first chain end and the second chain end wrap around the first rail end and the second rail end, respectively, and extend into the interior channel of the channel member. Moreover, in these embodiments, the first chain end and the second chain end may each be pinned within the interior channel of the channel member.

Embodiments described herein may also include the slidable room assembly that further comprises a pair of second drive chains that are each respectively attached to the opposing sidewalls of the slide-out unit, a first of the second pair of drive chains is spaced from a first of the first pair of drive chains on a first of the opposing sidewalls of the slide-out unit, and a second of the second pair of drive chains is spaced from a second of the second pair of drive chains on a second of the opposing sidewalls of the slide-out unit; and each of jamb members includes a second drive shaft arranged within the channel of the jamb member and a second drive sprocket that is arranged on an end of the second drive shaft and configured to engage one of the pair of second drive chains, wherein the second drive sprockets rotate with the second drive shafts to engage the pair of second drive chains and thereby move the slide-out unit between the extended position and the retracted position. In these embodiments, the pair of first drive chains and the pair of second drive chains may each be arranged within a channel member that is secured to each of the opposing sidewalls of the slide-out unit and, in these embodiments, each of the channel members may include a pair of channel member sidewalls and a rail that together define a chain channel, and wherein the first drive chain and the second drive chain may be arranged within the chain channel. Also in these embodiments, each of the channel members may further include an interior channel defined by the channel member sidewalls and the rail, wherein the rail interposes the interior channel and the chain channel. In addition, in these embodiments each of the first drive chains and each of the second drive chains may include a first chain end and a second chain end, the first chain end and the second chain end extending beyond a respective first rail end and second rail end of the chain rail when the first drive chains and the second drive chains are arranged within the chain channel, and wherein the first chain end and the second chain end wrap around the first rail end and the second rail end, respectively, and extend into the interior channel of the channel member. Moreover, in these embodiments, the first chain end and the second chain end may each be pinned within the interior channel of the channel member.

Embodiments described herein may also include the slidable room assembly that further comprises a timing assembly arranged within each of the pair of jamb members, wherein the timing assembly couples the first drive shaft to the second drive shaft such that that they rotate together. In these embodiments, each of the timing assemblies may include a first timing sprocket arranged on the first drive shaft, a second timing sprocket arranged on the second drive shaft, and a belt extending around and coupling the first and second timing sprockets such that the first drive shaft and the second drive shaft rotate together. In other embodiments, each of the timing assemblies may include a first bevel gear arranged on the first drive shaft, a second bevel gear arranged on the second drive shaft, and a timing shaft having a first and second mating bevel gear arranged thereon, the first mating bevel gear being arranged on the timing shaft to engage the first bevel gear and the second mating bevel gear being arranged on the timing shaft to engage the second bevel gear.

### BRIEF DESCRIPTION OF THE DRAWINGS

The following figures are included to illustrate certain aspects of the present disclosure, and should not be viewed as exclusive embodiments. The subject matter disclosed is capable of considerable modifications, alterations, combinations, and equivalents in form and function, without departing from the scope of this disclosure.

FIG. 1 is an isometric side view of an exemplary recreational vehicle having a slide-out unit in accordance with the present disclosure where the slide-out unit is in the retracted position.

FIG. 2 is an isometric side view of the exemplary recreational vehicle of FIG. 1, illustrating the slide-out unit in the extended position.

FIG. 3 is an isolated isometric top view of the exemplary slide-out unit of FIG. 2, illustrating the slide-out unit forming a room extension when in the extended position.

FIG. 4 is an isometric side view illustrating certain aspects of an exemplary slide-out drive assembly, according to one or more embodiments.

FIG. 5A is a close up isometric view of a first area identified as area X in FIG. 4.

FIG. 5B is a close up isometric view of a second area identified as area Y in FIG. 4.

FIG. 5C is a close up isometric view of a third area identified as area Z in FIG. 4.

FIGS. 6A-6C illustrate side views of the slide-out drive assembly of FIG. 4 as it articulates a slide-out room from the retracted position to the extended position.

FIGS. 7A-7H illustrate various views of the slide-out drive assembly of FIG. 4 arranged within an exemplary jamb member according to one or more embodiments.

FIGS. 8A-8H are detailed views of the drive chain assemblies utilized with the slide-out drive assembly of FIG. 4, according to one or more embodiments.

FIG. 9 illustrates a pair of mounting brackets utilized to attach the drive chain assemblies of FIGS. 8A-8E to a slide-out unit, according to one or more embodiments.

FIGS. 10A-10C illustrate alternate embodiments of the slide-out drive assembly of FIG. 4.

FIGS. 11A-11B illustrate alternate embodiments of the slide-out drive assembly of FIG. 4 utilizing multiple motors.

FIGS. 12A-12C illustrate alternate embodiments of the slide-out drive assembly of FIG. 4 that include drive extension assemblies, according to one or more embodiments.

FIGS. 13A-13B illustrate alternate embodiments of the slide-out drive assembly of FIG. 4 that include timing shafts, according to one or more embodiments.

### DETAILED DESCRIPTION

The present disclosure is related to slidable unit assemblies and, more particularly, to drive mechanisms for slide-out rooms and slide-out compartments for vehicles.

The embodiments described herein provide a slide-out unit (i.e., a slide-out room, a slide-out compartment, etc.) having a pair of synchronized drive mechanisms that are installed at opposing sides or walls of the room and each configured to drive the room at a top and a bottom corner thereof relative to the vehicle. In some embodiments, these synchronized drive mechanisms each include a jamb that houses a sprocket that drives a drive chain that is attached to a side of the slide-out unit. Other embodiments described herein provide a pair of synchronized drive mechanisms that utilize one or more gears and corresponding racks instead of the foregoing sprockets and corresponding drive chains. In even other embodiments described herein, a pair of synchronized drive mechanisms include each include a jamb with a pair of sprockets provided therein, where a timing belt is arranged on the pair of sprockets within the jamb, and a plurality of drive cables are connected to the timing belt and extend from the jamb to connect to the room.

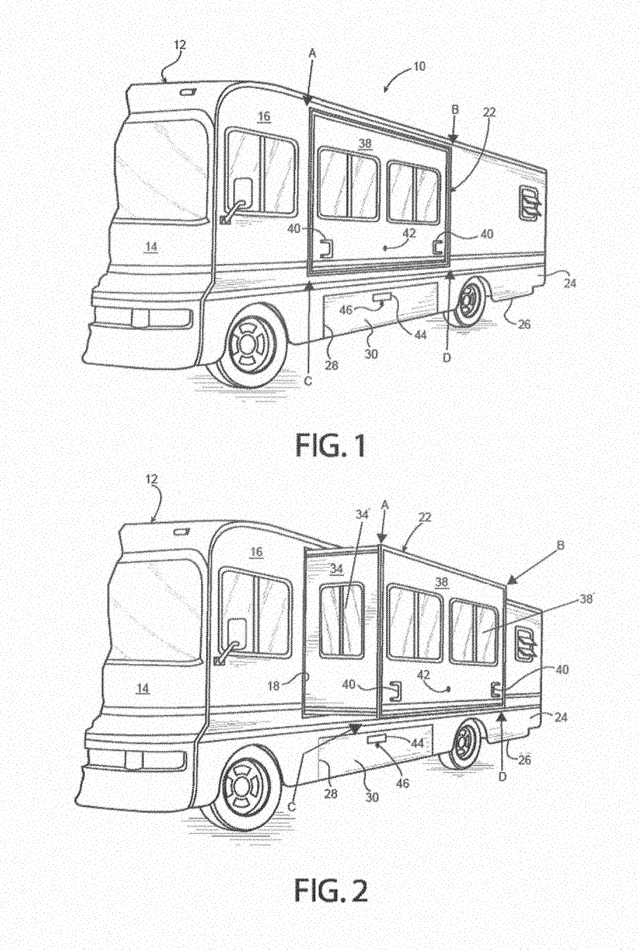

FIGS. 1-3 illustrate an example vehicle 10 that may incorporate the principles of the present disclosure. The depicted vehicle 10 is just one exemplary vehicle that may incorporate the principles of the present disclosure. Indeed, many alternative designs and configurations of the vehicle 10 may be employed without departing from the scope of this disclosure. For example, the vehicle 10 may be a motor home, a fifth wheel trailer, a travel trailer, a utility trailer, or various other types of recreational or non-recreational vehicles. In addition, the vehicle 10 may be one that is designed for living (e.g., as a house trailer) or one that may be designed for work (e.g., a mobile office or library). Accordingly, the vehicle 10 may be a self-powered vehicle or may be a trailer that is adapted to be towed, for example, by an automobile or truck.

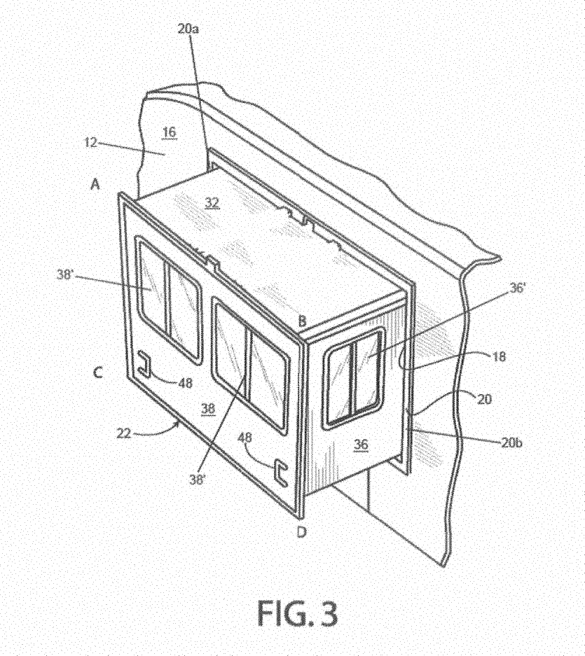

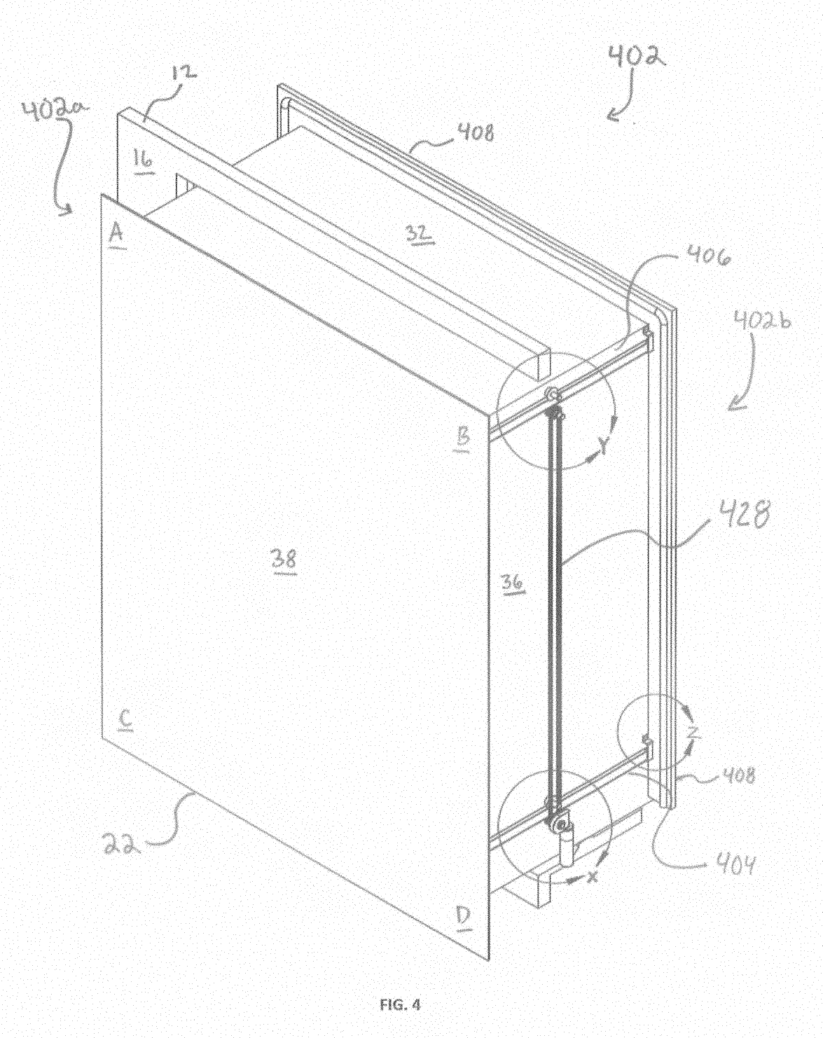

As illustrated, the vehicle 10 includes a body 12 and a slide-out room 22 that is configured to slide relative to the body 12 between a retracted position (FIG. 1) and an extended position (FIGS. 2-3). The body 12 defines an interior space (not shown) within which the occupants of the vehicle 10 may live and/or work, and this interior space may be expanded via one or more slide-out rooms and/or slide-out compartments, such as the slide-out room 22. While these figures illustrate the vehicle 10 having a single extendible slide-out room 22, in other embodiments, it may include more than one extendible slide-out rooms and/or compartments.

The vehicle body 12 may comprise a plurality of exterior walls, for example, a roof (obscured from view), a front wall 14, a left sidewall 16, a right sidewall (obscured from view), and a rear wall (obscured from view). Additionally, the interior of the vehicle body 12 also includes a floor (not shown). Beneath the floor is a conventional frame (not shown) for supporting the vehicle body 12, and that frame may be either a conventional or a nonconventional frame.

In the illustrated embodiments, the left sidewall 16 includes an opening 18 and a jamb 20. As illustrated, the jamb 20 extends along the vertical and horizontal edges of the opening 18 and receives the slide-out room 22. The opening 18 in the left side 16 of the vehicle body 12 may have any number of geometries depending upon the geometry of the slide-out room 22 and, in the illustrated embodiments, the opening 18 is rectangular and has a perimeter that includes horizontal top and bottom edges and vertical side edges. The jamb 20 is illustrated as being a rectangular structure continuously disposed along these edges, however, in other embodiments, the jamb 20 may include discrete jamb portions that each correspond to one or more of the foregoing edges.

As described below, the slide-out room 22 may be provided with an actuation system or drive mechanism that reciprocates it between the retracted and extended positions. In some embodiments, a portion of the drive mechanism is housed within the jamb 20. As illustrated, for example, the jamb 20 includes a left jamb 20a and a right jamb 20b that each houses a portion of the drive mechanism; however, in other embodiments, the drive mechanisms are differently housed, for example, in the bottom and/or top jamb portions. Thus, drive mechanisms may be provided in any or all of the left jamb 20a, the right jamb 20b, the bottom jamb, and/or the top jamb.

In some embodiments, the vehicle 10 may further include one or more additional or auxiliary slide-out compartments. As illustrated in FIGS. 1-2, the body 12 includes a lower portion or skirt 24 that is disposed below the floor of the vehicle 10 and which terminates in a lower edge 26 and, in such embodiments, slide-out compartments may be arranged within the skirt 24. Either or both of the left sidewall 16 and/or the right sidewall (obscured from view) may include an opening 28 for receiving an auxiliary slide-out unit and, in the illustrated embodiment, the left sidewall 16 includes a slide-out compartment 30. As will be appreciated, an actuating system or drive mechanism (not illustrated) is provided for reciprocating the slide-out compartment 30 between extended and retracted positions, and, in some embodiments, such drive mechanism is similar to that utilized to actuate the slide-out room 22. However, it will be appreciated that the drive mechanism of the slide-out compartment 30 may be smaller and less powerful in embodiments where the slide-out compartment 30 is lighter than the slide-out room 22. It will also be appreciated that there may be any number of such openings 28 equal to the number of the slide-out compartments 30, and that the openings 28 may be of any number of geometries depending on the geometry of the slide-out compartment 30. Moreover, the opening 28 (or any of them) may be located at various locations about the body 12 and, in the illustrated embodiment, the opening 28 is disposed along the lower edge 26 of the left sidewall 16.

The vehicle 10 may have various arrangements of slide-out rooms and/or compartments. In the illustrated embodiments, for example, the vehicle 10 includes one extendible slide-out room 22 and one extendible slide-out compartment 30. In other non-illustrated embodiments, the vehicle 10 may include two or more of the slide-out rooms 22 and/or two or more slide-out compartments 30. However, it will also be appreciated that the vehicle 10 may include one or more slide-out rooms 22 without any slide-out compartments 30, and vice versa. Regardless of the exact configuration, it will be appreciated that the slide-out rooms and compartments 22,30 should always be retracted when the vehicle 10 is in motion. And, when the vehicle 10 is parked or stationary, the slide-out room 22 may be articulated into its extended position (FIGS. 2 and 3) to afford additional space within the interior of the vehicle 10. Similarly, the slide-out compartment 30 may be actuated when the vehicle 10 is at rest.

As illustrated, the slide-out room 22 may generally have the same cross-sectional shape as the opening 18 in the vehicle body 12; and, while the same may be true of the slide-out compartment 30 and the opening 28, the remainder of this disclosure is made with reference to the slide-out room 22. In the illustrated embodiments, the slide-out room 22 includes a floor (obscured in figures), a ceiling 32, a left sidewall 34 and a right sidewall 36 (as viewed from the exterior of the vehicle 10 looking in), and a forward or outside wall 38. In some embodiments, the slide-out room 22 may include one or more windows arranged on any of the ceiling 32, the left sidewall 34 and/or the right sidewall 36, and/or the outside wall 38. For example, the slide-out room 22 is illustrated as including a left and right window 34′,36′ on the left and right sidewalls 34,36, respectively, as well as a front window 38′ on the outside wall 38. For reference, the four corners of the slide-out room 22 are referenced using letters A, B, C, and D, as shown in FIGS. 1-3.

As illustrated, the outside wall 38 of the slide-out room 22 is substantially coplanar or flush with (but may be spaced slightly outward from) the left sidewall 16 of the vehicle body 12 when the slide-out room 22 is retracted (FIG. 1), and is parallel to and spaced outwardly from the left sidewall 16 of the vehicle body 12 when the slide-out room 22 is extended (FIG. 2). In addition, the right sidewall 36 is disposed in a rearward direction of the vehicle body 12, and the left sidewall 34 is disposed in a forward direction of the vehicle body 12. The spacing between the left and right sidewalls 34,36 is slightly less than a width of the opening 18 in the vehicle body 12, which affords enough clearance for sliding movement of the slide-out room 22 while minimizing the intrusion of the elements into the vehicle body 12 such as wind and rain. As will be appreciated, the size of the outside wall 38 may be slightly greater than the size of the opening 18 (with the jamb 20) in the vehicle body 12 so that the edges of the outside wall 38 overlie the vehicle body 12 as an aid in maintaining an effective seal when the slide-out room 22 is retracted. In addition, one or more seals (not shown) may be provided around the perimeter of the opening 18 in a similar fashion to provide an effective means for sealing the slide-out compartment 30 when retracted within the vehicle body 12.

In certain embodiments, for example, where manual operation and/or manual servicing is desired, one or more handles 40 may be provided on the front wall of the slide-out room 22, so that the slide-out room 22 may be opened and closed manually. In at least some of these embodiments, a lock 42 may be provided to selectively secure the slide-out room 22. Moreover, the lock 42 may be provided in addition to the functioning of the actuation system or drive mechanism (detailed below) to lock the slide-out room 22 in position when it is at rest (whether retracted, extended or in-between). Similarly, the slide-out compartment 30 may be provided with a handle 44 for manual operation and a lock 46, as detailed with reference to the slide-out room 22.

In the illustrated embodiments, however, the slide-out room 22 is driven with a slide-out drive assembly that transmits force to the slide-out room 22 resulting in smooth, even actuation of the slide-out room 22 along its predetermined path, with no tendency to twist or bind and with minimum power input. In these embodiments, the slide-out drive assembly transmits force evenly to the opposing left and right sidewalls 34,36 of the slide-out room 22, whereas in other embodiments force may be transmitted to either or both of the ceiling 32 and/or the floor (not shown) of the slide-out room 22. In even other embodiments, the slide-out drive assembly may transmit force evenly to the opposing left and right sidewalls 34,36 and either or both of the ceiling 32 and/or the floor of the slide-out room 22.

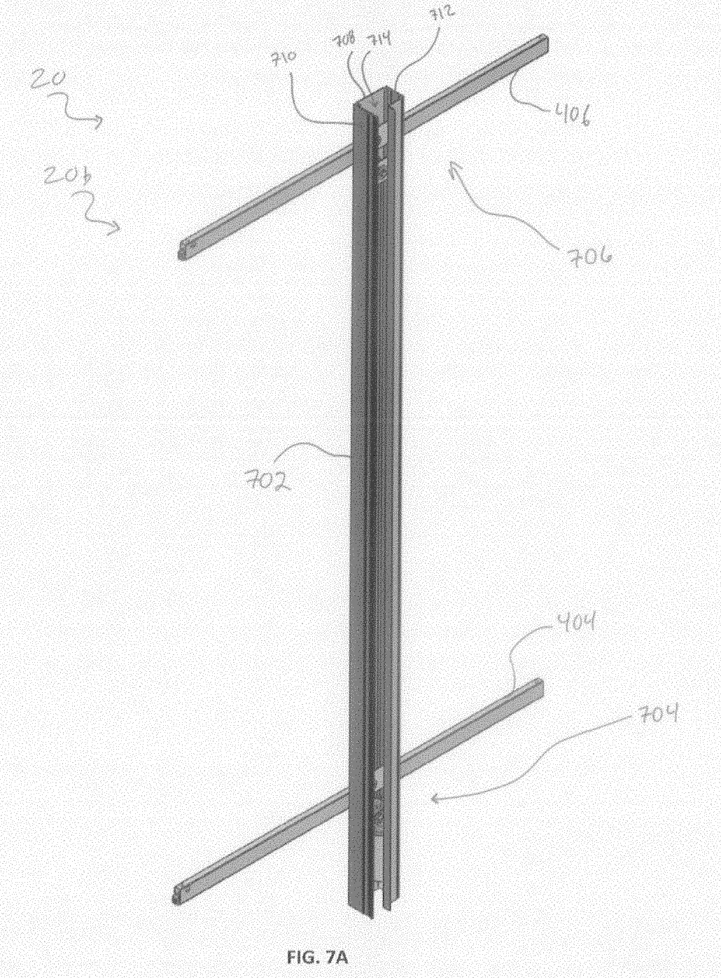

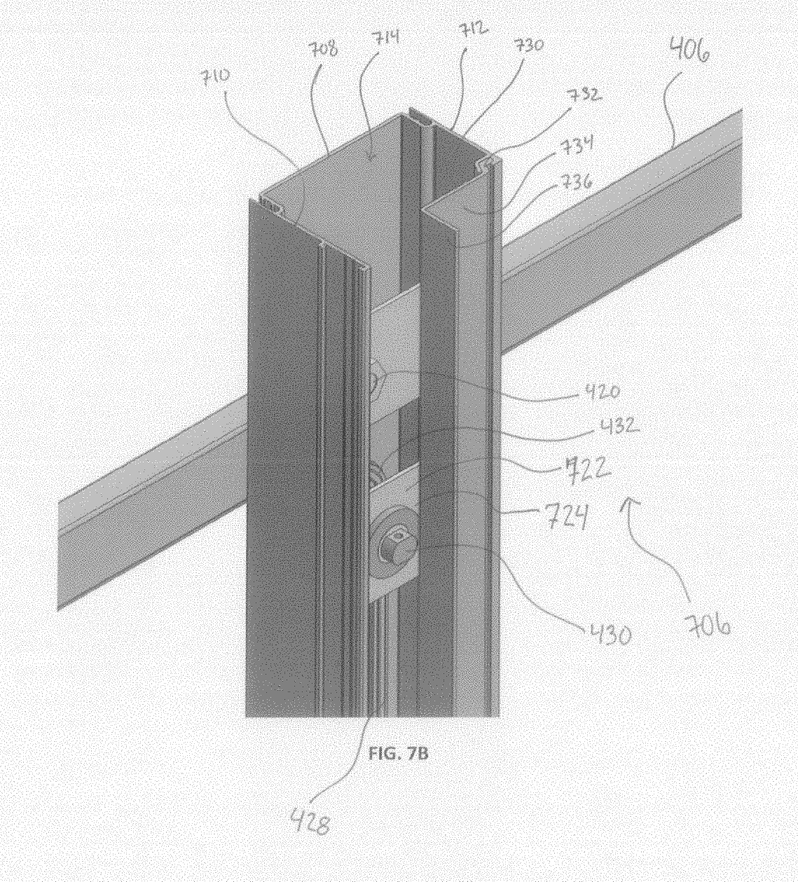

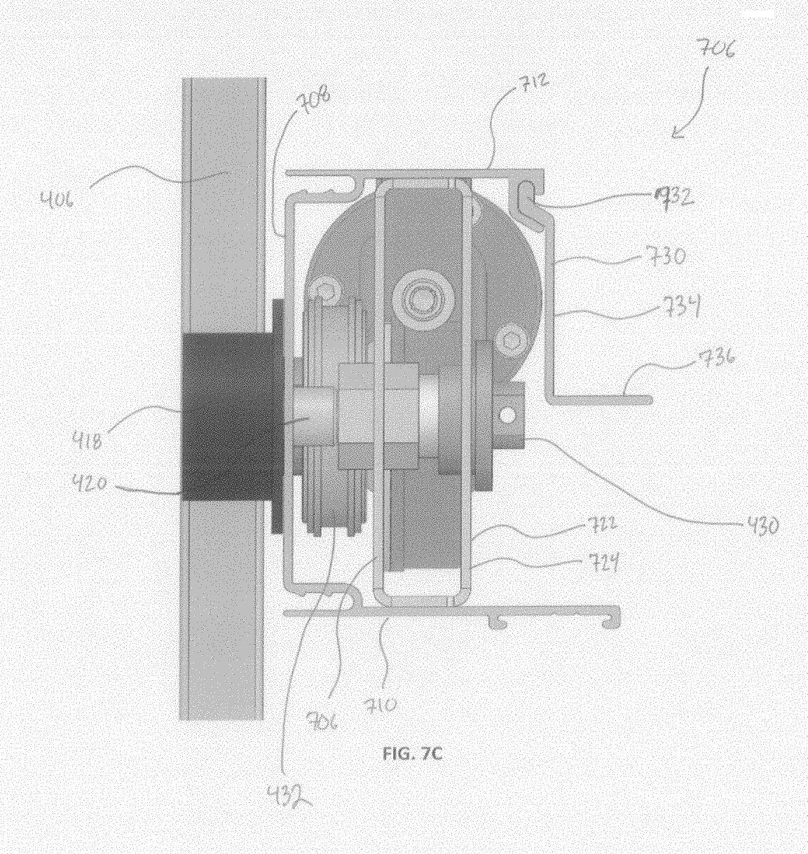

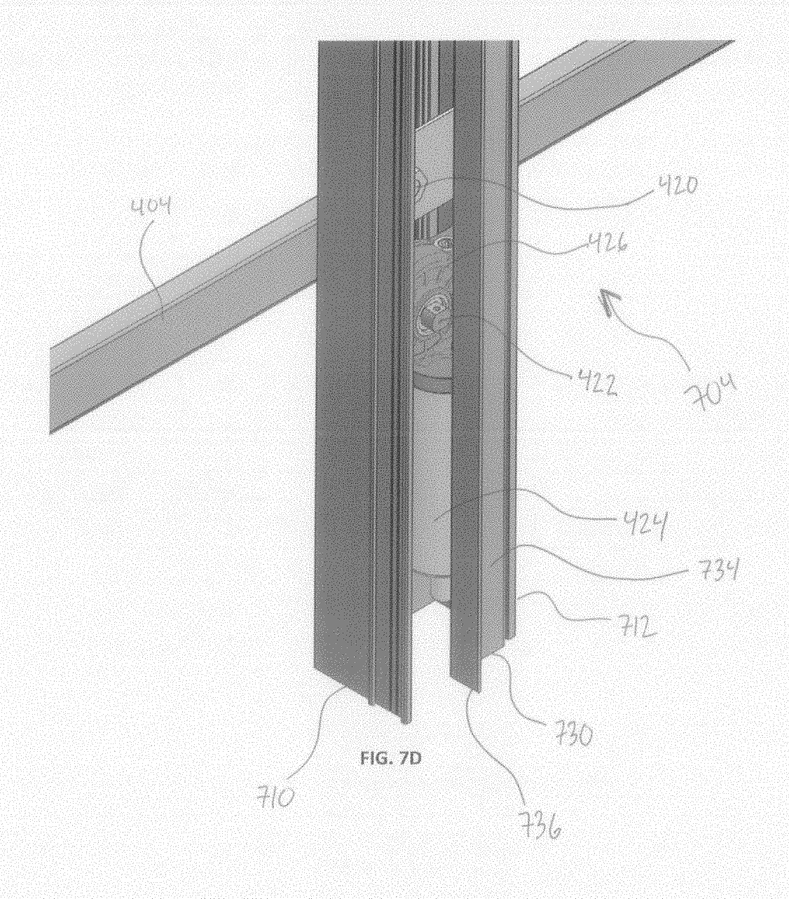

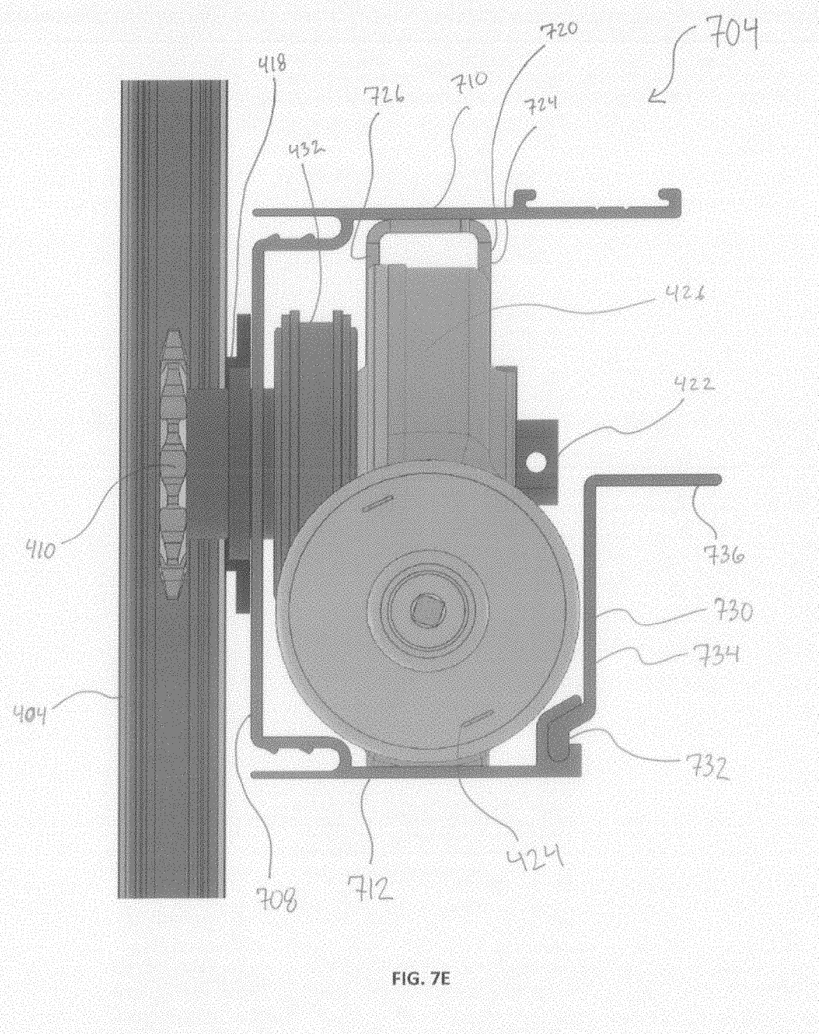

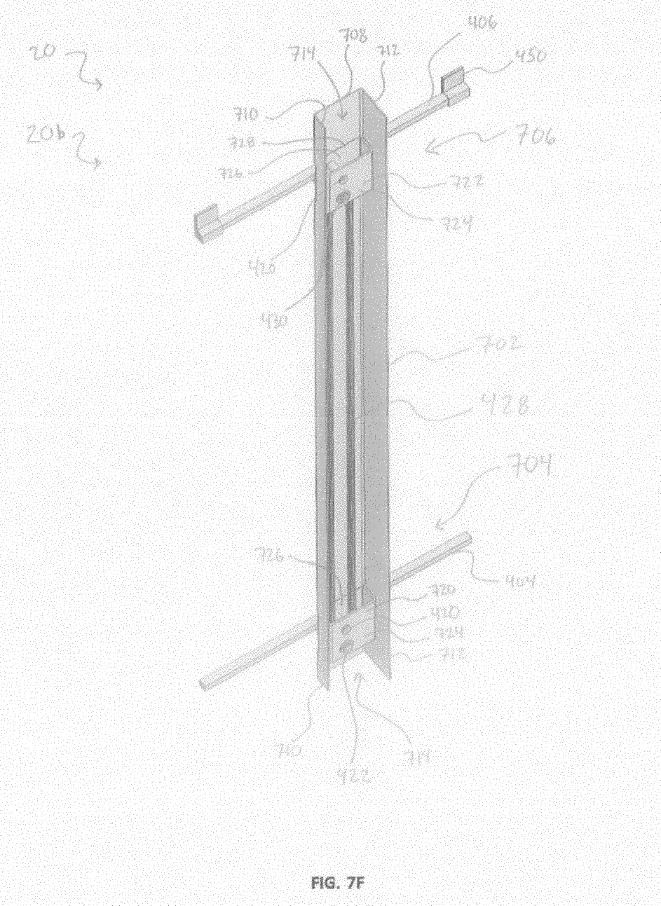

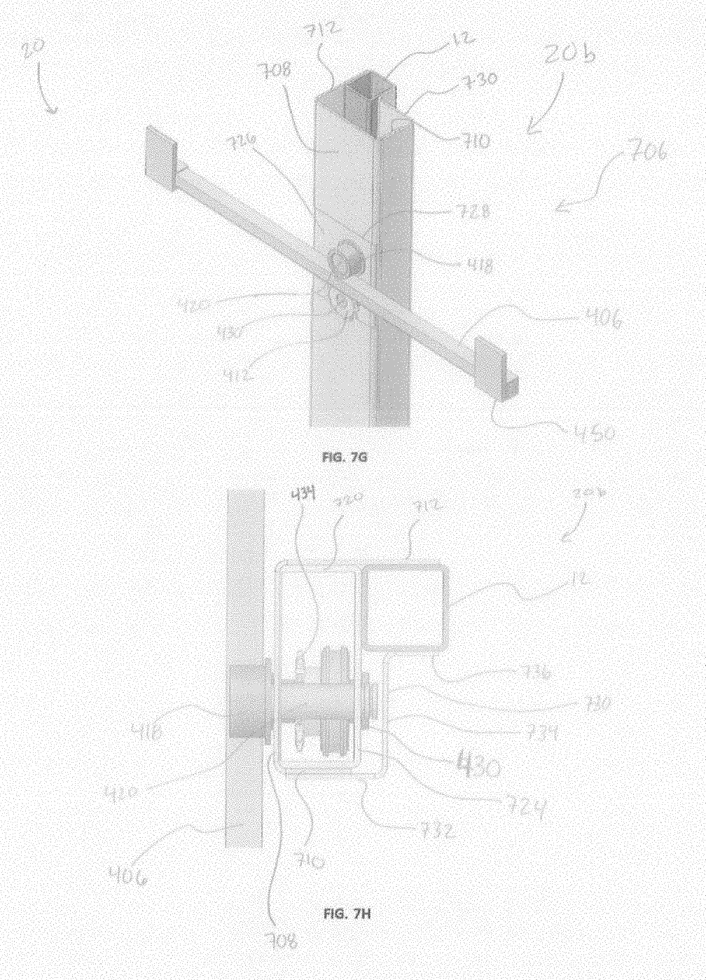

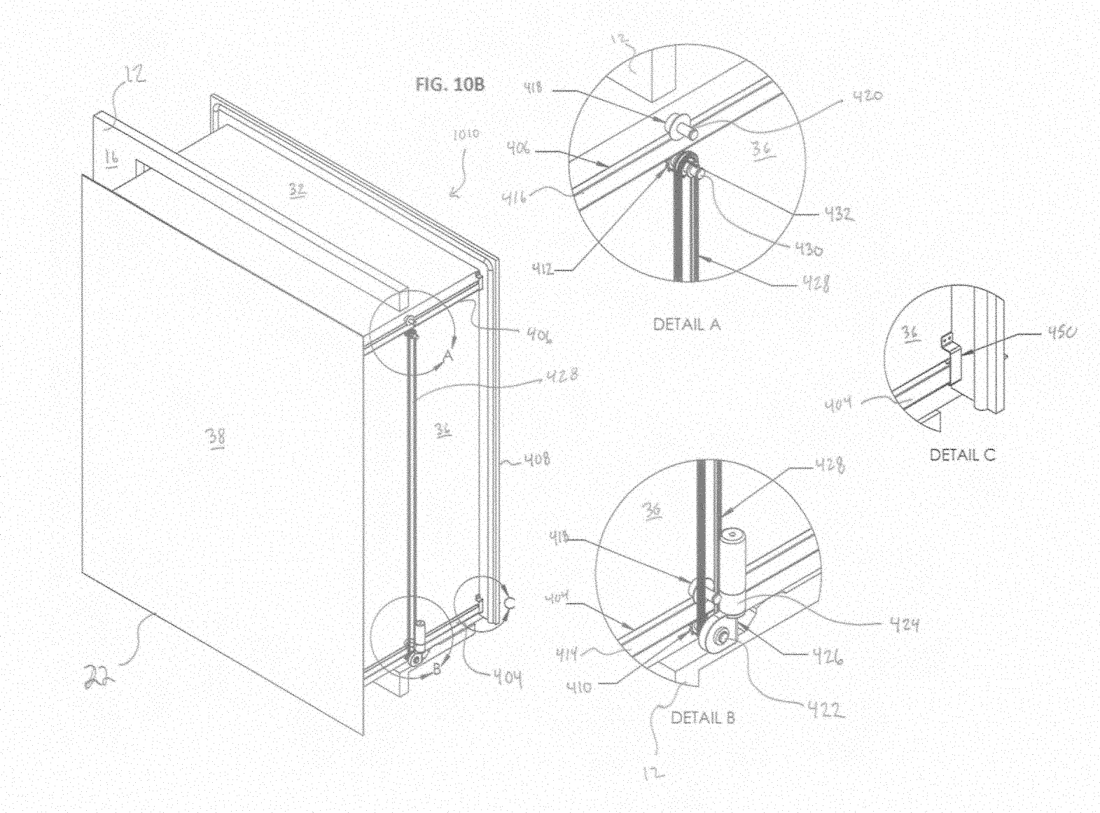

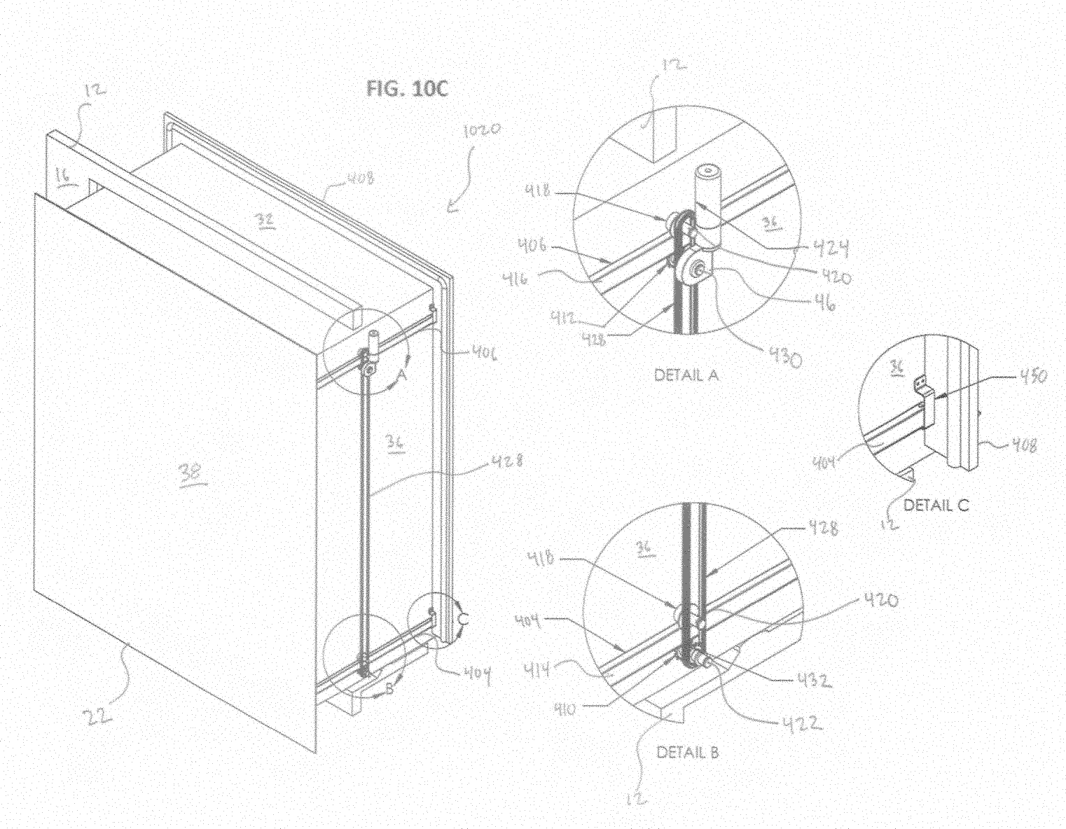

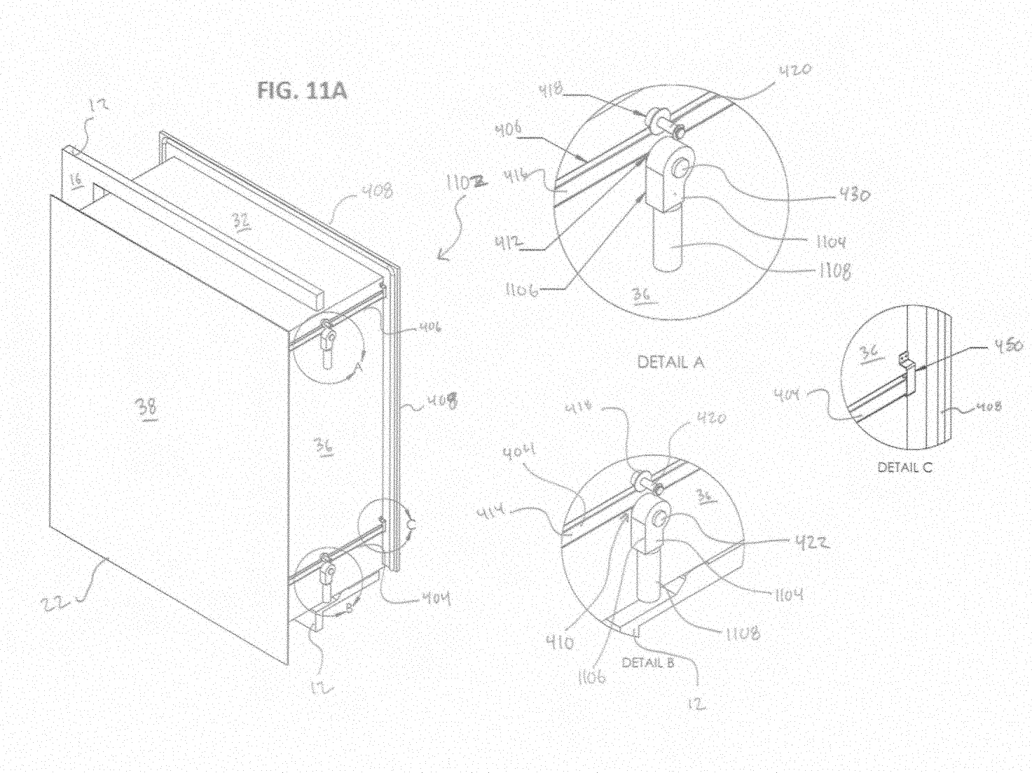

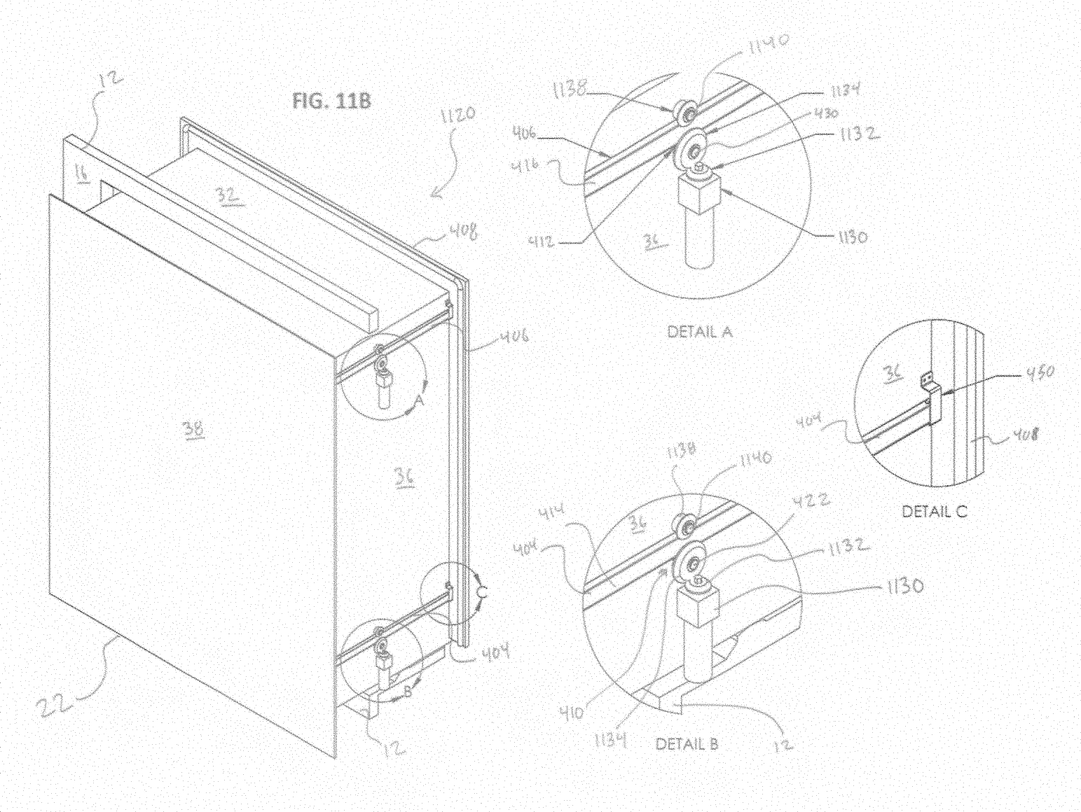

One example drive assembly is illustrated in FIG. 4, and this exemplary slide-out drive assembly generally includes drive mechanism elements (e.g., drive chains and drive sprockets) and timing mechanism elements (e.g., timing chains, timing sprockets, etc.); however, the drive assembly may be configured differently as hereinafter described with reference to FIGS. 10-13. For example, the drive mechanism elements of the slide-out drive assembly may include pinion and rack gears instead of chains and sprockets, or the drive mechanism elements of the slide-out drive assembly may include drive cables. And, as will be appreciated with reference to FIGS. 7A-7H, these drive mechanism elements and timing mechanism elements are at least partially arrangeable within one or more jambs/housings (not illustrated in FIGS. 4-6) that are secured to the vehicle body 12, for example, the interior of the left and right jambs 20a,b that are secured to the left sidewall 16.

FIG. 4 is an isometric side view of an exemplary slide-out drive assembly 402 according to one or more embodiments of the present disclosure. More specifically, FIG. 4 illustrates a right side 402b of the exemplary slide-out drive assembly 402 engaging and transmitting force to the right sidewall 36 of the slide-out room 22, but without the right jamb 20b that may be included to house certain components of the slide-out drive assembly 402 and secure the same to the vehicle body 12. It will be appreciated, however, that a left side slide-out drive assembly 402a (not illustrated) may be similarly arranged on the left sidewall 34 of the slide-out room 22 to ensure even and uniform actuation along the opposing left and right sidewalls 34,36 of the slide-out room 22.

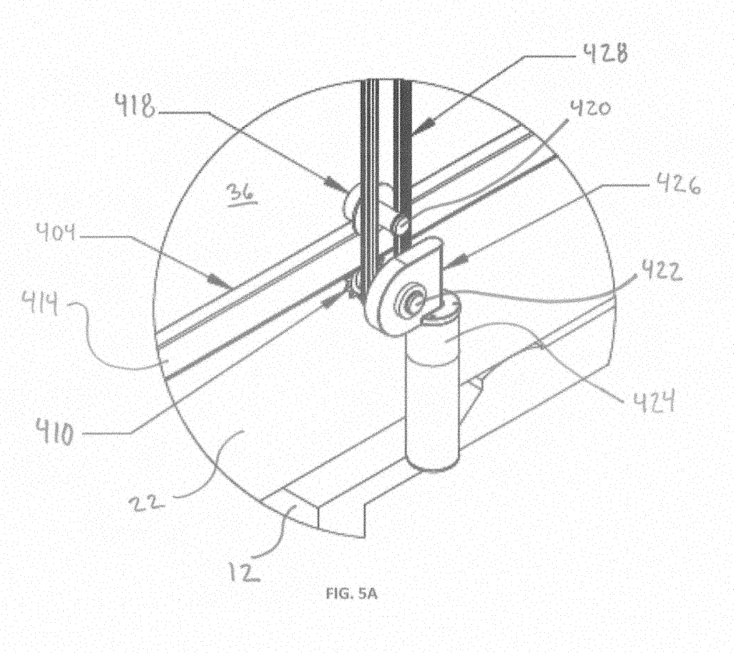

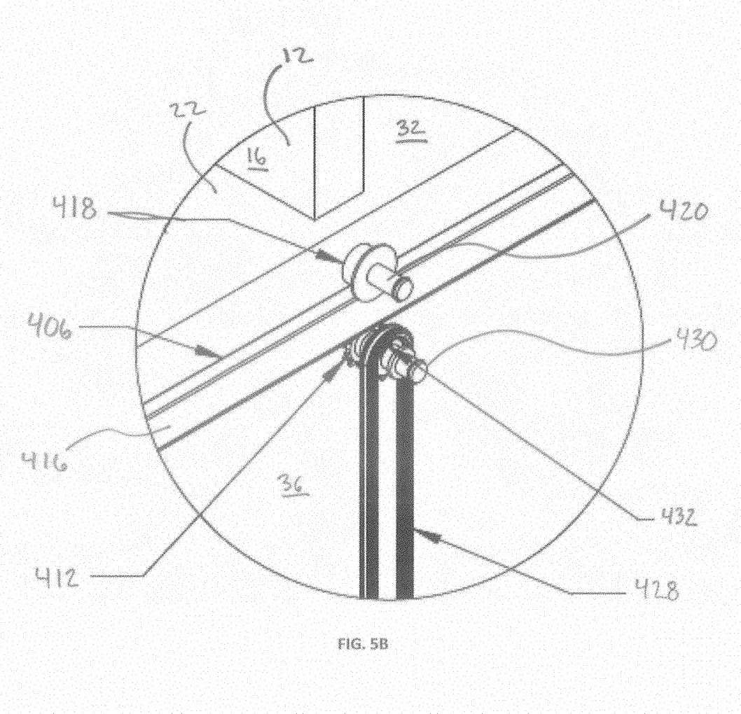

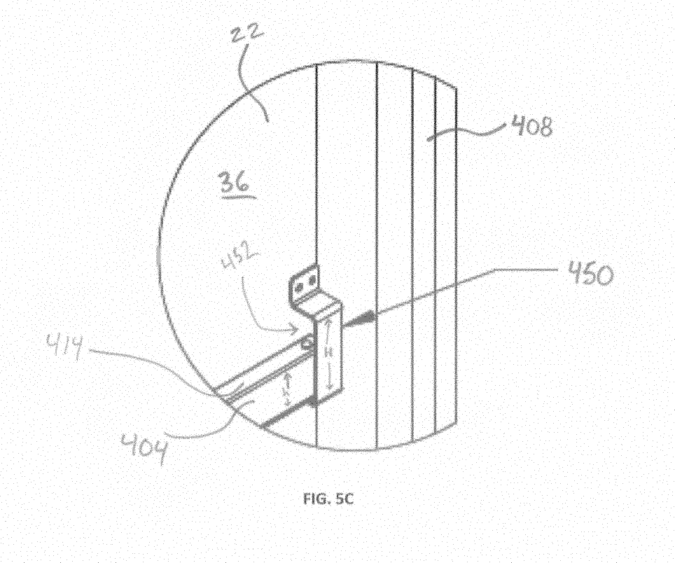

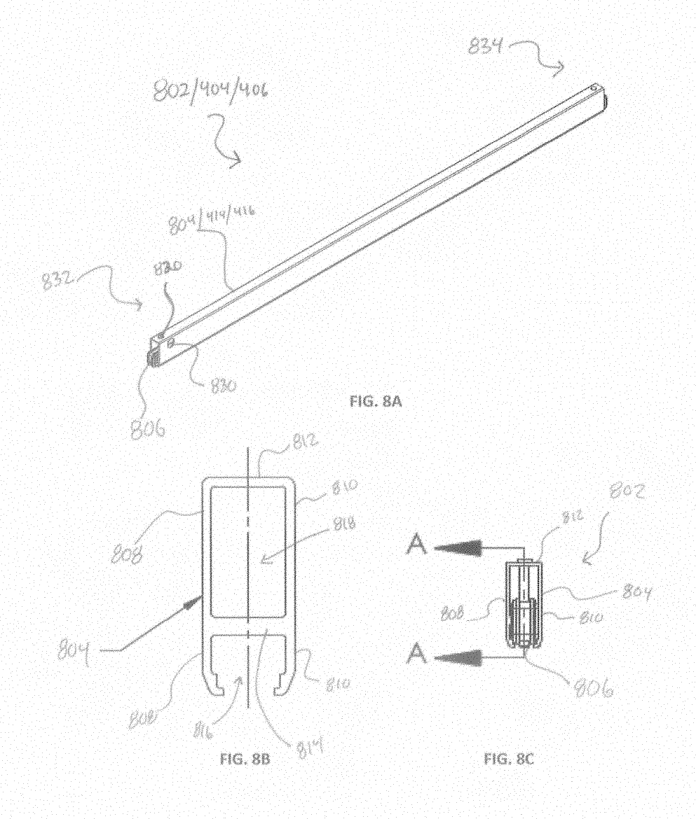

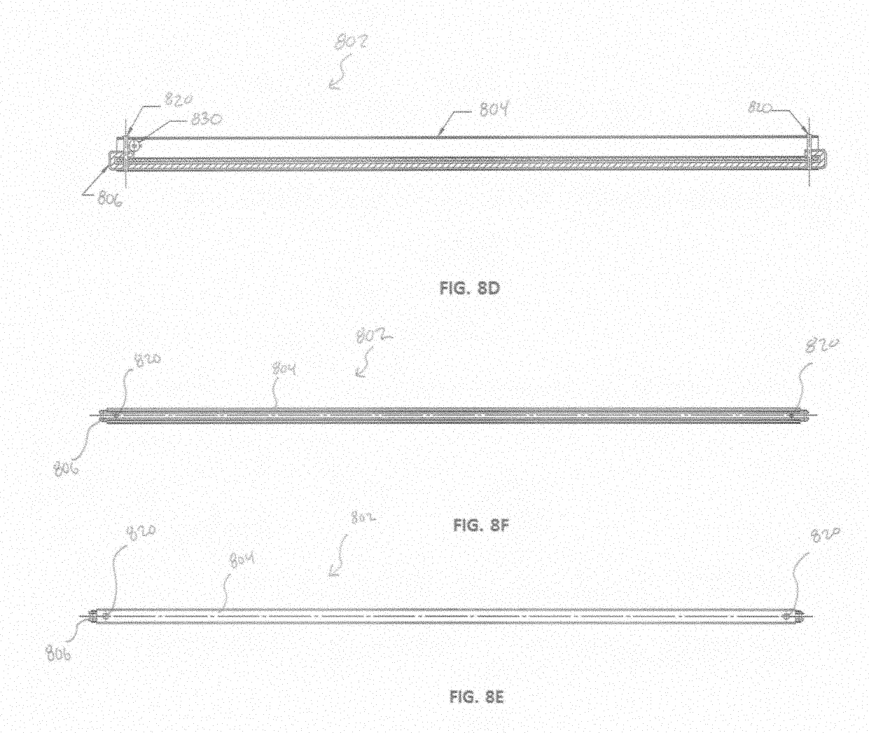

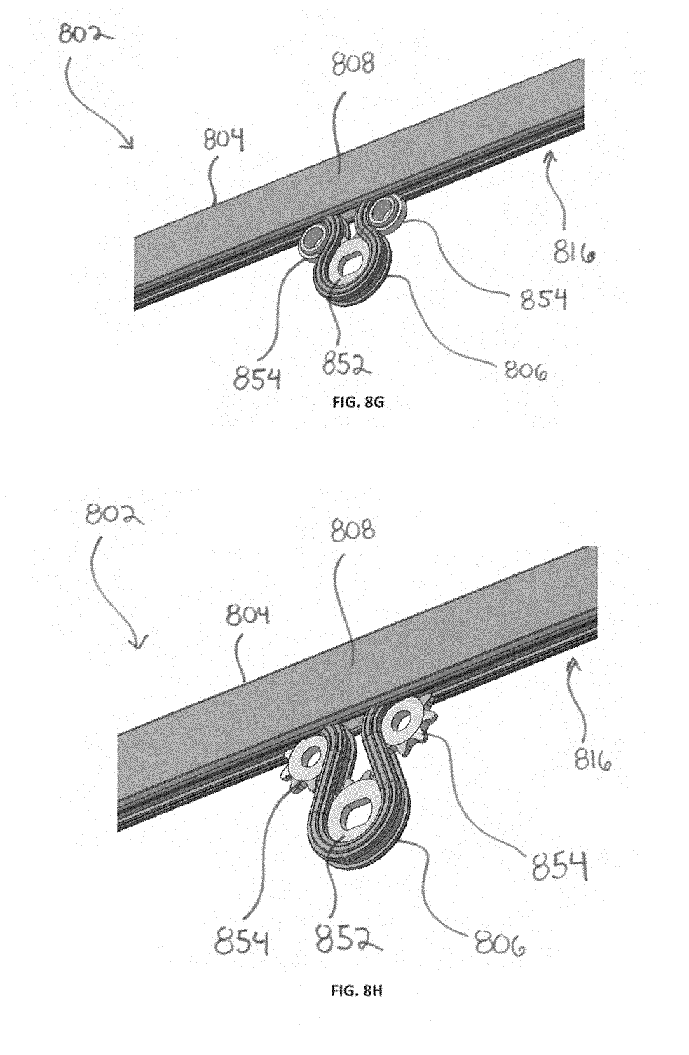

As illustrated in FIG. 4, the right side slide-out drive assembly 402b includes a pair of drive members configured as a pair of drive chain assemblies 404,406 that are installed at vertically spaced locations along the right sidewall 36 of the slide-out room 22. The drive chain assembly 404 is installed along a lower portion of the slide-out room 22, between the outside wall 38 and a rear frame 408 of the slide-out room 22, and is engaged or driven as illustrated in FIG. 5A. Accordingly, the drive chain assembly 404 is said to correspond with corner D of the slide-out room 22, and the length that the drive chain assembly 404 extends (together with the other drive chain assemblies) generally defines the amount of extension that a slide-out unit may exhibit in a particular application. The drive chain assembly 404 is engaged or driven at a first area X (which has been enlarged in FIG. 5A). The drive chain assembly 406 is similarly arranged, except that it is installed along an upper portion of the right sidewall 36 (between the outside wall 38 and the rear frame 408) and is thus said to correspond with the corner B of the slide-out room 22. Thus, the drive chain assembly 406 is engaged or driven at a second area Y (which has been enlarged in FIG. 5B). In addition, FIG. 4 shows the drive chain assemblies 404,406 being constrained or slidingly attached to the right sidewall 36, for example, as illustrated with the drive chain assembly 404 being attached thereto a third area Z (which has been enlarged in FIG. 5C). It will be appreciated that the drive chain assembly 406 may be similarly configured as illustrated with respect to the drive chain assembly 404 in FIG. 5C. And, while not illustrated, it will be appreciated that the left side slide-out drive assembly 402a may include similarly arranged drive chain assemblies disposed along the left sidewall 34 so as to correspond with the corners C,A of the slide-out room 22. The drive chain assemblies, such as the drive chain assemblies 404,406, are further described below, for example, with reference to FIGS. 8A-8H.

As illustrated in FIGS. 5A-5B, the right side slide-out drive assembly 402b includes a pair of drive chain sprockets 410,412 that engage the drive chain assemblies 404,406, respectively. Here, the drive chain sprocket 410 is a lower drive chain sprocket and the drive chain sprocket 412 is an upper drive train sprocket. More specifically, the drive chain sprocket 410 engages a lower drive chain (obscured; see, for example, FIGS. 8A and 8C) that is set within a channel member 414 of the (lower) drive chain assembly 404, whereas the drive chain sprocket 412 engages an upper drive chain (obscured; see, for example, FIGS. 8A and 8C) that is set within a channel member 416 of the (upper) drive chain assembly 406. It will be appreciated that, as the drive chain sprockets 410,412 may each engage their respective drive chain (not shown) from beneath, the channel members 414,416 may supported from above by a respective roller member 418 extending from a roller shaft 420. In particular, FIG. 5A illustrates the engagement of the drive chain assembly 404 between the drive chain sprocket 410 and the first roller member 418, and FIG. 5B illustrates the engagement of the second drive chain assembly 406 between the second drive chain sprocket 412 and the second roller member 418. Where utilized, either or both of the roller members may be connected to the drive chain assemblies 404,406, for example, via their respective roller shaft 420.

As illustrated in FIG. 5A, the drive chain sprocket 410 is disposed on a drive shaft 422 that is actuated by a motor 424 such that the drive chain sprocket 410 rotates with the drive shaft 422. In the illustrated embodiment, a gear box 426 is utilized to transfer power (i.e., torque) from an output shaft (not shown) of the motor 424 to the drive shaft 422 that rotates the drive chain sprocket 410. In this example, the gear box 426 is a worm gear box; however, it will be appreciated that other gear boxes may be utilized, for example, bevel gear boxes. In addition, while various types of actuators or motors may be utilized, in at least some embodiments, the motor 424 is either a self-locking worm drive or a planetary gear motor with an electric brake. Also in the illustrated embodiment, each side 402a,b of the slide-out drive assembly 402 includes an actuator, such as the motor 424. In such embodiments that utilize more than one actuator or motor, the actuators or motors may be synchronized with each other to ensure even and uniform articulation at all sides/corners of the slide-out room 22, for example, using Hall Effect sensors (not illustrated) that may be arranged to count revolutions of the motor 424.

The actuators, such as the motors 424, or any of them, may be powered by the vehicle, include a battery (e.g., a rechargeable battery), or be connected to a renewable power source, such as a solar powered generator, a vehicle mounted wind turbine generator, etc. Alternatively, a portable motor or a hand crank may be used instead of the motor 424 and/or gear box 426. Whatever form of power input is used, however, the slide-out room 22 may be locked in position when it is not in motion. When used, a worm drive performs a locking function when the slide-out room 22 is at rest, locking the slide-out room 22 in place (for example, in a closed position when fully retracted), so that a separate lock is not necessary. With other drive mechanisms, a locking means (e.g., a cam lock, or clamp in the walls of slide-out unit 22) may be used to retain the slide-out room 22 in position.

A timing sprocket (obscured from view behind the gear box 426) may be provided on the drive shaft 422 such that the timing sprocket rotates with the drive chain sprocket 410 and the drive shaft 422 (at corner D of the slide-out room 22). Here, the timing sprocket interposes the drive chain sprocket 410 and the gear box 426, and receives a timing chain or timing belt 428. A timing sprocket may be utilized, for example, in embodiments where the right side slide-out drive assembly 402b includes a single actuator, such as the motor 424, such that the motor 424 may be utilized to drive the (lower and upper) drive chain assemblies 404,406 together and in unison (i.e., to “time” the drive chain assemblies 404,406 so that they are driven simultaneously).

As illustrated in FIG. 5B, the drive chain sprocket 412 is similarly disposed on a drive shaft 430 (corresponding to corner B) so that the drive chain sprocket 412 rotates with the drive shaft 430. In addition, a timing sprocket 432 is also similarly disposed on the drive shaft 430 to rotate with the drive chain sprocket 412 and to receive the timing belt 428, and the timing sprocket 432 may be secured thereon at a location that corresponds with the location of the timing sprocket (obscured from view) on the drive shaft 422 as described with reference to FIG. 5A. Accordingly, the timing belt 428 couples the (first) drive shaft 422 to the (second) drive shaft 430 such that a rotation of the (first) drive shaft 422 rotates the (second) drive shaft 430, and vice versa. As will be explained in more detail below, the motor 424, the timing belt 428, portions of the drive shafts 422,430, and portions of the roller shafts 420 may be arranged within a structure, such as the jamb 20, so that the drive chain sprockets 410,412 and the roller members 418 protrude therefrom to engage the drive chain assemblies 404,406 as illustrated in FIGS. 5A and 5B.

The timing belt 428 synchronizes rotation of the lower and upper drive shafts 422,430 such that the lower and upper drive sprockets 410,412 engage the lower and upper drive chain assemblies 404,406, respectively, in unison. It will be appreciated, however, that the forgoing timing mechanisms are optional, and that each of the drive chain assemblies 404,406 could be driven by a discrete motor, which may be synchronized (e.g., a lower and an upper motor that are synchronized with each other via a Hall Effect sensor or feedback). In other embodiments, it will be appreciated that the slide-out drive assembly 402 may instead drive the slide-out room 22 without any timing components, for example, at a single side, a pair or more of sides, or at a pair or more of corners (e.g., at the corners C and D of the slide-out room 22). In even other embodiments, a timing shaft and a set of bevel gears operatively connected thereto may be utilized in lieu of the foregoing timing components (e.g., the timing belt 428 and the timing sprockets 432).

FIG. 5C illustrates how the drive chain assembly 404 may be secured to the right sidewall 36 of the slide-out room 22 according to one or more embodiments. While only illustrating the (lower) drive chain assembly 404, it will be appreciated that the same may similarly apply with regard to the (upper) drive chain assembly 406 or other drive chain assemblies that may be installed on the left sidewall 34 or elsewhere about the slide-out room 22. In the illustrated embodiment, a support bracket or bracket 450 is utilized to secure an end of the drive chain assembly 404 that is proximate to the rear frame 408 of the slide-out room 22. When installed on the slide-out room 22 (e.g., on the right sidewall 36) over the channel member 414, the bracket 450 defines an interior space or channel 452 having a vertical dimension “H” (i.e., a height) that is greater than a vertical dimension “h” of the channel member 414, which is being bracketed against the vehicle body 12 via the bracket 450. This arrangement permits relative movement of the channel member 414 within the bracket 450, for example, when the slide-out room 22 is extended and/or “dropped” as described below.

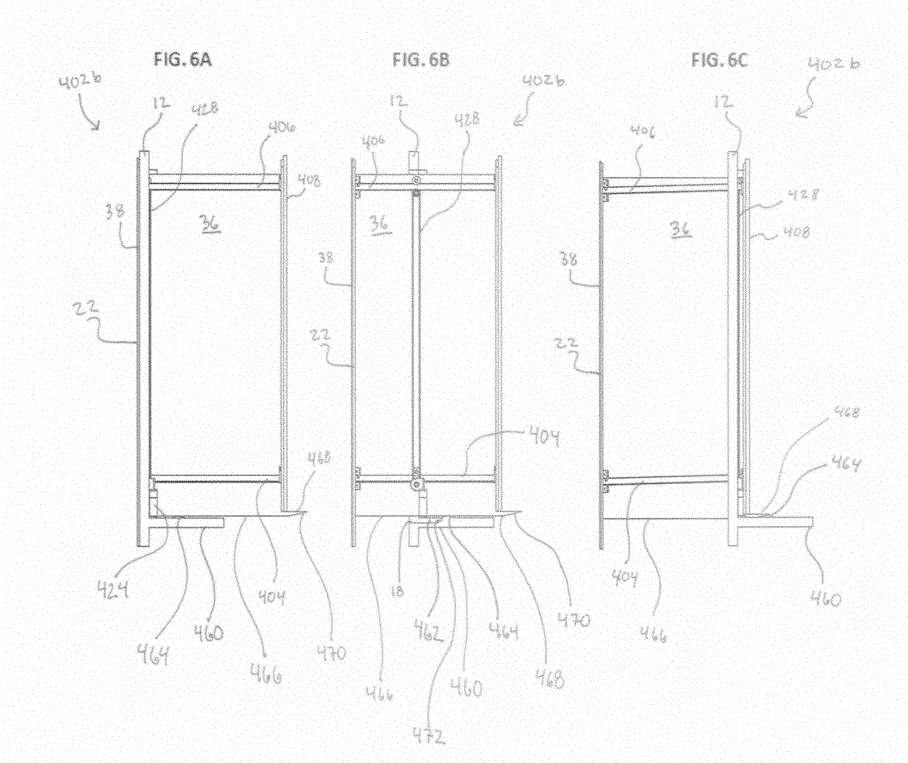

As illustrated in FIGS. 6A-6C, the slide-out drive assembly 402 actuates the slide-out room 22 from a fully retracted position (FIG. 6A), along a predetermined path (an intermediate position of the predetermined path is illustrated in FIG. 6B), and to a fully extended position (FIG. 6C). When the slide-out unit 22 is fully retracted within the vehicle 10, as illustrated in FIG. 6A, it rides up above an interior floor 460 of the vehicle 10. The interior floor 460 of the vehicle 10 may include a slide-out extension slot 462 leading inwardly from the opening 18 and into a lip 464 of the interior floor 460, and the slide-out room 22 sits on the lip 462 when retracted within the vehicle 10 and slides upon the lip 462 as it extends outward from the opening 18 of the vehicle 10. The slide-out room 22 includes a floor 466 and, in this embodiment, the floor 466 includes a lip engagement member 468 that extends beyond the rear frame 408 of the slide-out room 22. Here, the lip engagement member 468 has an upwardly inclined/sloped face 470 that engages a mating surface 472 of the lip 462 and, as will be appreciated, this facilitates providing the slide-out room 22 in a fully extended position where its interior floors (not shown) are substantially coplanar with the interior floors (not shown) of the vehicle 10. In addition, the sloped face 470 of the engagement member 468 facilitates the engagement member 468 riding along and over the mating surface 472 of the lip 462, for example, when the slide-out room 22 is articulated from a fully extended position to a retracted position. It will be appreciated that all of the forgoing contact surfaces, for example, of the lip 462, the engagement member 468 and its sloped face 470 may all have lubricious contact surfaces (or other low friction surface finishes) that facilitate smooth articulation.

During operation, securing the drive chain assembly 404 to the slide-out room 22 with the bracket 450 (that permits relative motion as previously described) facilitates the slide-out room 22 to “drop” into the extended position illustrated in FIG. 6C. For example, the floor 466 of the slide-out room 22 travels along the lip 464 until the lip engagement member 468 guides the slide-out room 22 downward along its sloped face 470 that interacts with the mating surface 472 of the lip 464 on the interior floor 460 of the vehicle 10. In this example, when the slide-out room 22 is in the fully extended position (FIG. 6C), the sloped face 470 of the lip engagement member 468 is fully engaged with the mating surface 472 of the lip 464. The bracket 450 permits relative motion between the slide-out room 22 and slide-out drive assembly 402 that is secured to the vehicle body 12 such that the drive assembly 402 is not damaged when the slide-out room 22 “drops” into its extended position (i.e., when the slide-out room 22 moves vertically relative to the remainder of the vehicle body 12). In this manner, as the slide-out room 22 is fully extended from the vehicle, the sloped face 470 of the lip engagement member 468 rides over and down past the lip 464 such that the interior floor (not shown) of the slide-out room 22 is substantially coplanar with the interior floor (not shown) of the vehicle 10.

As previously mentioned, aspects of the slide-out drive assembly 402 may be provided within a jamb structure that is secured to the vehicle body 12. FIGS. 7A-7H illustrate portions of the right side slide-out drive assembly 402b arranged within the right jamb 20b according to one or more embodiments. In such embodiments, it will be appreciated that the left jamb 20a (and/or any other jamb structure(s) disposed around the opening 18) may be similarly arranged. The right jamb 20b includes a jamb member 702. In the illustrated embodiment, the jamb member 702 is an elongated extrusion having a lower end 704 (corresponding to the corner D) and an upper end 706 (corresponding to the corner D). The jamb member 702 includes a web portion 708 and a pair of legs 710,712 extending from a bottom side of the web portion 708 such that the jamb member 702 has a “C” shape cross-section and defines an interior channel 714, and the interior channel 714 may be utilized to both connect the right jamb 20b to the vehicle body 12 and/or to house at least some (or a portion of some) of the right side slide-out drive assembly 402b components as described below. In the illustrated embodiment, the second leg 712 is shorter than the first leg 710 of the jamb member 702 due to the manner in which the right jamb 20b is secured to the vehicle body 12 via a jamb clamp 730. However, the jamb member 702 may be differently dimensioned or configured depending on the vehicle 10 to which it is to be attached.

In the illustrated embodiments, a pair of channel frames 720,722 are provided within the channel 714 at the lower and upper ends 704,706 of the jamb member 702, respectively. It will be appreciated that while the channel frames 720,722 were not depicted in FIGS. 5A-5B, respectively, structures such as the channel frames 720,722 may be utilized to position and/or secure the drive shafts 422,430, roller shafts 420, and/or the motor 424, and/or other components relative to the drive chain assemblies 404,406.

Here, each of the channel frames 720,722 is illustrated as being open rectangular cross-section members each having a rear face 724 and a front face 726. In some embodiments, the channel frames 720,722 are disposed within the channel 714 so that each face 724,726 is contained within the envelope defined by the jamb member 702. In other embodiments, the web portion 708 is formed with a recess 728 sized to receive the front face 726 as best shown in FIGS. 7F-7H. However, either or both of the channel frames 720,722 may instead be single frame members spanning approximately parallel to the web portion 708, or instead be “C” shaped cross-section members that are oriented within the channel 714 such that the “C” shape cross-section of the channel frames 720,722 is 180 degrees opposite of the “C” shaped cross-section of the jamb member 702; and, in this manner, the channels 720,722 will not be nested within the jamb member 702. Rather, the channels 720,722 each include a rear face 724 that together define a rear boundary of the channel 714. Alternatively, the channel frames 720,722 may be a planar member similarly disposed within the channel 714 as the foregoing “C” shaped cross-section members.

The jamb clamp 730 may be provided to secure the jamb member 702, for example, to the vehicle body 12. In the illustrated embodiment, the jamb clamp 730 includes a first flange 732 that is arranged to correspond with (or nest within) a mating recess of the second leg 712 (of the jamb member 702); a web portion 734 that extends from the first flange 732 in a substantially coplanar orientation relative to the web portion 708 (of the jamb member 702); and a second flange 736 that extends from the web portion 734 in a substantially coplanar orientation relative to the first leg 710 (of the jamb member 702). As will be appreciated, the first flange 732 of the jamb clamp 730 may be secured to the first leg 710 of the jamb member 702 via a friction press-fit as illustrated; however, it may be differently secured or include additional securing methods such as, for example, by use of welding, fasteners, adhesives, etc. Accordingly, the jamb clamp 730 may be utilized to wedge or clamp a portion of the vehicle body 12 within the jamb 20.

Either or both of the channel frames 720,722 within jamb member 702 may have an upper and/or lower aperture (both obscured from view) that extend through the rear and front faces 724,726 thereof. FIG. 7F illustrates an example where these apertures formed into the rear faces 724 of the (lower and upper) channel frames 720,722; whereas FIG. 7G illustrates these apertures formed into the front faces 726 of the same. As will be appreciated, these apertures are arranged to receive one of the drive shafts 422,430 and/or the roller shafts 420. In other embodiments, however, the drive shafts 422,430 and/or the roller shafts 420 extend from the right sidewall 36 of the slide-out room 22 rather than jamb assembly as previously described. In other embodiments, the channel frames 720,722 are arranged to receive only the drive shafts 422,430, and the roller shafts 420 are secured to the jamb 20, for example, at the web portion 708.

In the illustrated embodiment, the (lower) channel frame 720 includes an aperture that receives the drive shaft 422. In some embodiments, the channel frame 720 includes a second aperture that receives the roller shaft 420. Regardless, it will be appreciated that a rear end of each of the roller shaft 420 and the drive shaft 422 may extend to or beyond the rear face 724, and a front end of each of the roller shaft 420 and the drive shaft 422 extends beyond the front face 726 and outward of the web portion 708 to receive the roller member 418 and the drive chain sprocket 410. With this arrangement, the (lower) drive chain assembly 404 is secured between the (lower) roller member 418 and the (lower) drive chain sprocket 410 when driven via the (lower) drive chain sprocket 410. Also in this embodiment, the timing sprocket (not illustrated) on the (lower) drive shaft 422 that engages the timing belt 428 is disposed between the rear and front faces 724,726. In addition, the motor 424 and gear box 426 may be similarly disposed between the rear and front faces 724,726, or may instead be disposed proximate to an outside of the rear face 724. Also, additional sprockets or gears may be provided on the (lower) drive shaft 422, for example, an extra sprocket 434 that may be utilized to engage a drive extension assembly as detailed below.

Similarly, the (upper) channel frame 722 may also include one or more apertures to receive the drive shaft 430 and/or the roller shaft 420 as previously described with reference to the (lower) channel frame 720. Thus, a rear end of each of the roller shaft 420 and the drive shaft 430 may extend to or beyond the rear face 724, and a front end of each of the roller shaft 420 and the drive shaft 430 extends beyond the front face 726 and outward of the web portion 708 to receive the roller member 418 and the drive chain sprocket 412. As such, the (upper) drive chain assembly 406 may be secured between the (upper) roller member 418 and the (upper) drive chain sprocket 412 when driven via the (upper) drive chain sprocket 412. Also in this embodiment, the timing sprocket 432 on the (upper) drive shaft 430 that engages the timing belt 428 is disposed between the rear and front faces 724,726. Also, additional sprockets or gears may be provided on the (upper) drive shaft 430, for example, the extra (third) sprocket 434 may be utilized to engage an upper motor and/or a drive extension assembly as detailed below.

Turning to FIGS. 8A-8F, various views of the drive chain assemblies 404,406 are illustrated according to one or more embodiments of the present disclosure. However, for ease of discussion, the drive chain assemblies 404,406 are each individually referred to as a drive chain assembly 802. FIG. 8A is an isometric side view of the drive chain assembly 802. Here, the drive chain assembly 802 includes a channel member 804 (that is arranged similarly to the channel members 414,416 described with reference to FIGS. 5A-5B) and a chain 806. The channel member 804 may be an elongate extruded piece in some embodiment. While various designs or types of the chain 806 may be utilized, the chain 806 may include a plurality of connected links that are suitably arranged to engage the drive chain sprockets 410,412, as described above. And, in some embodiments, the chain 806 is a standard size roller chain as categorized by the American National Standards Institute (ANSI), for example, roller chain standard 40, 50, 60, or 80.

FIG. 8B is a front view of the channel member 804 of FIG. 8A without the chain 806 mounted therein, whereas FIG. 8C illustrates the channel member 804 of FIG. 8B with the chain 806 installed therein. As illustrated, the channel member 804 includes a pair of sidewalls 808,810 that extend from a web portion 812 of the channel member 804, and a chain rail 814 arranged between the sidewalls 808,810 in a substantially coplanar orientation relative to the web portion 812 of the channel member 804 such that the sidewalls 808,810 extend past the chain rail 814. The portions of the sidewalls 808,810 that extend past the chain rail 814 and the chain rail 814 together define a chain channel 816. In addition, the sidewalls 808,810 and the chain rail 814 also define an inner recess or inner channel 818. As illustrated, the chain channel 816 is arranged to receive the chain 806 and secure it within the channel member 804 such that it may be engaged with a drive chain sprocket such as the drive chain sprockets 410,412, whereas the inner channel 818 is arranged to secure opposing ends of the chain 806 that extend from the chain channel 816.

FIG. 8D illustrates a side cut-away view of the drive chain assembly 802 along a section line A-A of FIG. 8C, according to one or more embodiments. FIG. 8E illustrates a top view of the drive chain assembly 802 of FIG. 8A, whereas FIG. 8F illustrates a bottom view of the drive chain assembly 802 of FIG. 8A. In the illustrated embodiment, the chain 806 has a length that is longer than the length of the channel member 804 (i.e., longer than the chain rail 814) such that when the chain 806 is disposed within the chain channel 816, extra lengths of chain exist and extend out of the chain channel 816 at each end; these extra lengths of chain may then be wrapped around the chain rail 814 into the inner channel where they are secured to the channel member 804, for example, via a pin 820. In the illustrated embodiment, a pin 820 is utilized to secure the chain 806 to the channel member 804 at each end thereof by extending (i) through the web portion 812 of the channel member 804, (ii) through the extra length of chain 806 that is wrapped into the inner channel 818, (iii) through the chain rail 814, and (iv) through a portion of the chain 806 disposed within the chain channel 816. It will be appreciated, however, that other means may be utilized to secure the chain 806 to the channel member 804. For example, the pin may extend through the web portion 812 and engage the chain 806 within the inner channel 818 with enough pressure such that the chain 806 is secured therein, similar to a press fit.

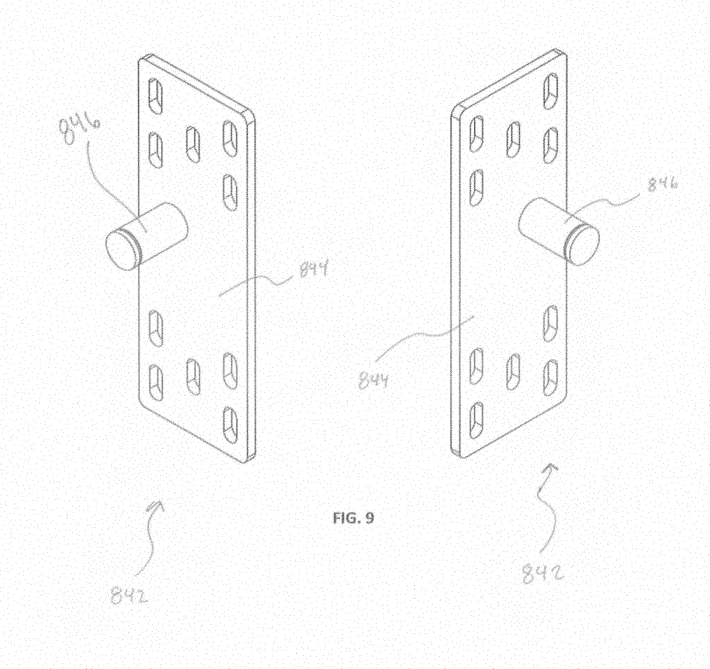

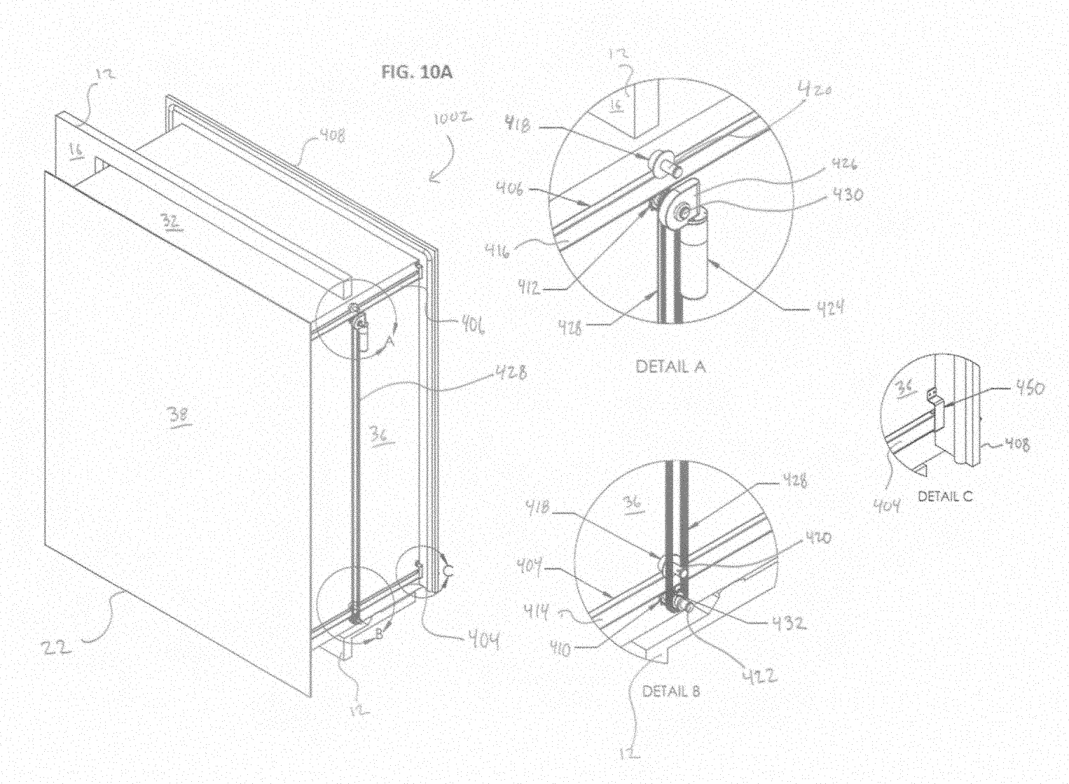

The channel member 804 may also include a mounting slot 830 at (at least) a first end 832 of the channel member 804. The mounting slot 830 may be arranged to receive a mounting bracket pin as described below with reference to FIG. 9. In the illustrated embodiment, however, a second end 834 of the channel member 804 is configured to be attached to the slide-out room 22 via the bracket 450 as described above with reference to FIG. 5C; however, the second end 834 may be similarly configured as with the first end 832.

FIGS. 8G and 8H illustrate alternate embodiments of the drive chain assembly 802 according to one or more other embodiments. In particular, FIGS. 8G and 8H illustrate an embodiment where the chain 806, or at least a portion of the chain 806, may extend outward of the chain channel 816 to engage a drive member, such as a drive sprocket 852, and be held within the chain channel 816 via a pair of chain guides 854. In the illustrated embodiment, the drive sprocket 852 engages a top side of the chain 806 rather than engaging the underside of the chain 806, as previously described with reference to FIGS. 8A-8F. Here, either or both of the drive sprockets 410,412 may be arranged as the drive sprocket 852 of FIGS. 8G-8H, where the drive sprocket 852 is offset or spaced from the channel member 804 such that its teeth or cogs engage a top side of the chain 806 at a location outside of the chain channel 816. In these embodiments, the chain 806 rests within the chain channel 816, but then exits the chain channel 816 to wrap around and engage at least a bottom portion of the drive sprocket 852. In some embodiments, the drive chain assembly 802 may include one or more chain guides 854 and, in the illustrated embodiments, two such chain guides 854 are provided to maintain the chain 806 within the chain channel 816 when not engaged by the drive sprocket 852. The chain guides 854, where utilized, may have various configurations. For example, the chain guides 854 of FIG. 8G are arranged as rollers, whereas the chain guides 854 of FIG. 8H are arranged as sprockets. The chain guides 854 may be secured to the drive chain assembly 802 at, for example, the channel member 804 (e.g., at the sidewalls 808/810). Alternatively, the chain guides 854 may be secured to the vehicle body 12, for example, via the jamb 20 (e.g., connected to the channel member 702). In even other embodiments, the chain guides 854 are coupled to the motor 424 and arranged to drive (or assist in driving) the slide-out room 22 as described herein; and in such configurations, the chain guides may be timed with the drive sprocket 852. In addition, one or more roller members 418 may be provided to ensure engagement between the drive sprocket 852 and the drive chain assembly 802 as hereinbefore described, and such roller members 418 may each extend from the roller shaft 420 as previously described.

FIG. 9 illustrates a pair of mounting brackets 842 according to one or more embodiments. The mounting brackets 842 may be utilized to attach the first end 832 (and/or the second end 834) of the drive chain assembly 802 to the slide-out room 22 as mentioned above. Here, each of the mounting brackets 842 includes a base 844 secured to the slide-out room 22 and a pin 846 extending outwardly therefrom. The base 844 may be attached to the slide-out room 22 via a number of fastening methods, for example, via utilization of fasteners or adhesives. The pin 846 is arranged within the mounting slot 830 such that the channel member 804 is able to rotate about the pin 846 relative to the plate 844 (and the slide-out room 22 secured thereto), thereby permitting the second end 834 to vertically translate within the channel 452 of the bracket 450 as described above with reference to FIG. 5C. In some embodiments, the pin 846 is made from a lubricious material; however, in other embodiments, a bushing or sleeve may be provided between the pin 846 and the mounting slot 830 to facilitate smooth rotation. Accordingly, in the illustrated embodiment, the first end 832 of the drive assembly 802 is mounted to the slide-out room 22 via pin 846 that permits relative rotation (about the pin 846) between the slide-out room 22 and the vehicle structure 12, whereas the second end 834 of the drive assembly 802 is mounted to the slide-out room 22 via the bracket 450 that permits relative movement between the slide-out room 22 and the vehicle body 12 (in at least a vertical direction).

It will be appreciated that, while not illustrated, the left side slide-out drive assembly 402a may be arranged similar to the right side slide-out drive assembly 402b as described in FIGS. 4-9.

It will also be appreciated that in certain environments, it may be desirable to protect the drive chain assemblies from dirt, debris, and/or moisture. This may be true in embodiments where the drive chain assemblies are mounted to the ceiling or upper surface of slide-out room 22. To this end, a protective surface (not illustrated) may be utilized to cover vulnerable drive chain assemblies, for example, the chain 806 therein. The protective surface may be a thin membrane or have a suitably configured sleeve that travels along any portion of drive chain assembly, and/or the chain 806 disposed therein, that may be subject to the accumulation of unwanted material. However, it is appropriate that the protective surface 150 not enter the engagement between a drive chain sprocket (e.g., 410,412) and a chain (e.g., the chain 806) in a drive chain assembly (e.g., 404,406). In some embodiments, a router (not illustrated) may be employed to the channel the protective surface around such engagement and, in one such embodiment, the router includes a series of traveler members therein that help to move the protective surface away from the sprocket/chain engagement as the slide-out room 22 is moved between retracted and extended positions. Alternatively, the protective surface could be collected and dispensed via an arrangement of one or more spools in which such spools are biased and take up excess slack as the slide-out unit drive assembly actuates.

The slide-out drive assembly 402 may also be modified in a number of ways. For example, the motor 424 may be moved from its position that is proximate to the (lower) drive shaft 422 (as illustrated in FIGS. 4 and 5A) to an upper position proximate to the (upper) drive shaft 430 (as illustrated in FIGS. 10A and 10C), and/or the motor 424 may be inverted so that its cylindrically extending base portion extends upward (as illustrated in FIGS. 10B and 10C) rather than downward (as illustrated in FIGS. 4, 5A and 10A). It will be appreciated that the motor 424 (or any of them, if more than one) may be differently oriented to extend at angles other than those illustrated in the figures, as may be needed in a particular application.

FIG. 10A illustrates the right side of a slide-out drive assembly 1002 according to one or more other embodiments. Here, the motor 424 and gear box 426 are disposed at an upper portion of the right sidewall 36 so as to the (upper) drive shaft 430 instead of the (lower) drive shaft 422 as illustrated in FIG. 4. Here, the (lower) drive shaft 422 includes a timing sprocket 1004 disposed thereon in a similar manner in which the timing sprocket 432 is disposed on the (upper) drive shaft 430 in FIG. 4.

FIG. 10B illustrates a slide-out drive assembly 1010 according to one or more other embodiments. The slide-out drive assembly 1010 is similar to the slide-out drive assembly 402 illustrated in FIG. 4, except that the motor 424 and the gear box 426 are inverted so that a body of the motor 424 extends upwards as illustrated in FIG. 10B.

FIG. 10C illustrates a slide-out drive assembly 1020 according to one or more other embodiments. The slide-out drive assembly 1020 is similar to the slide-out drive assembly 1002 illustrated in FIG. 10A, except that the motor 424 and the gear box 426 are inverted so that a body of the motor 424 extends upwards in a similar fashion as described with reference to FIG. 10B.

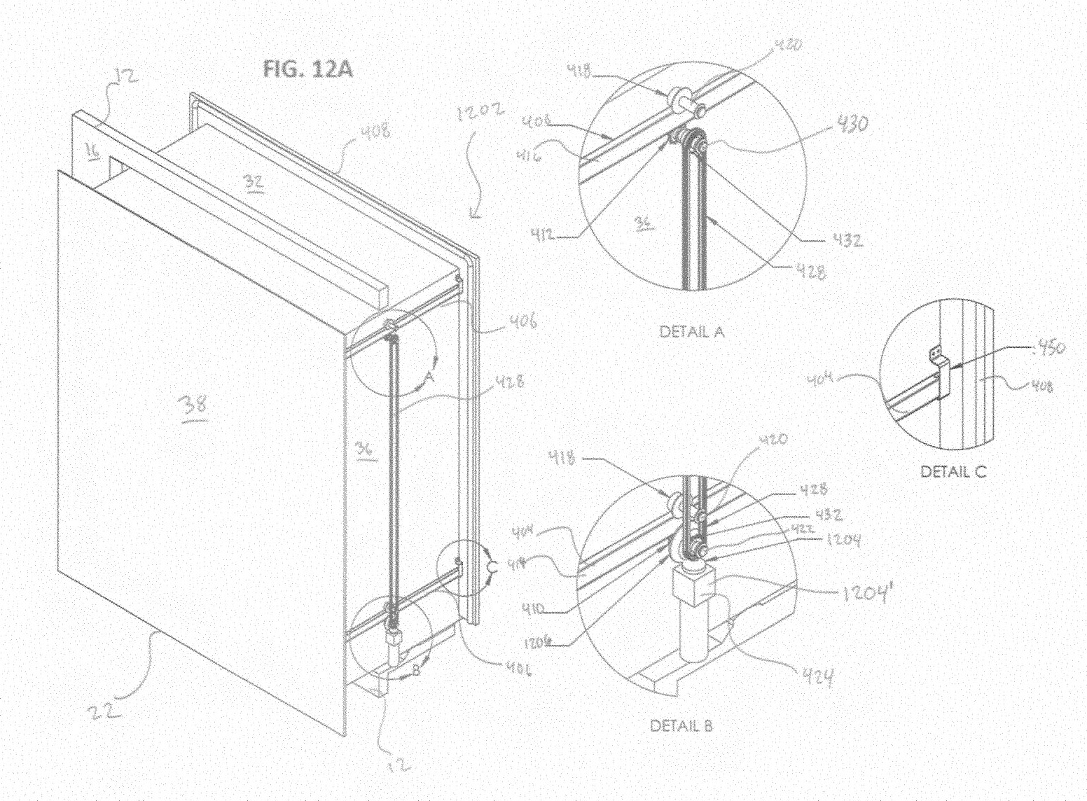

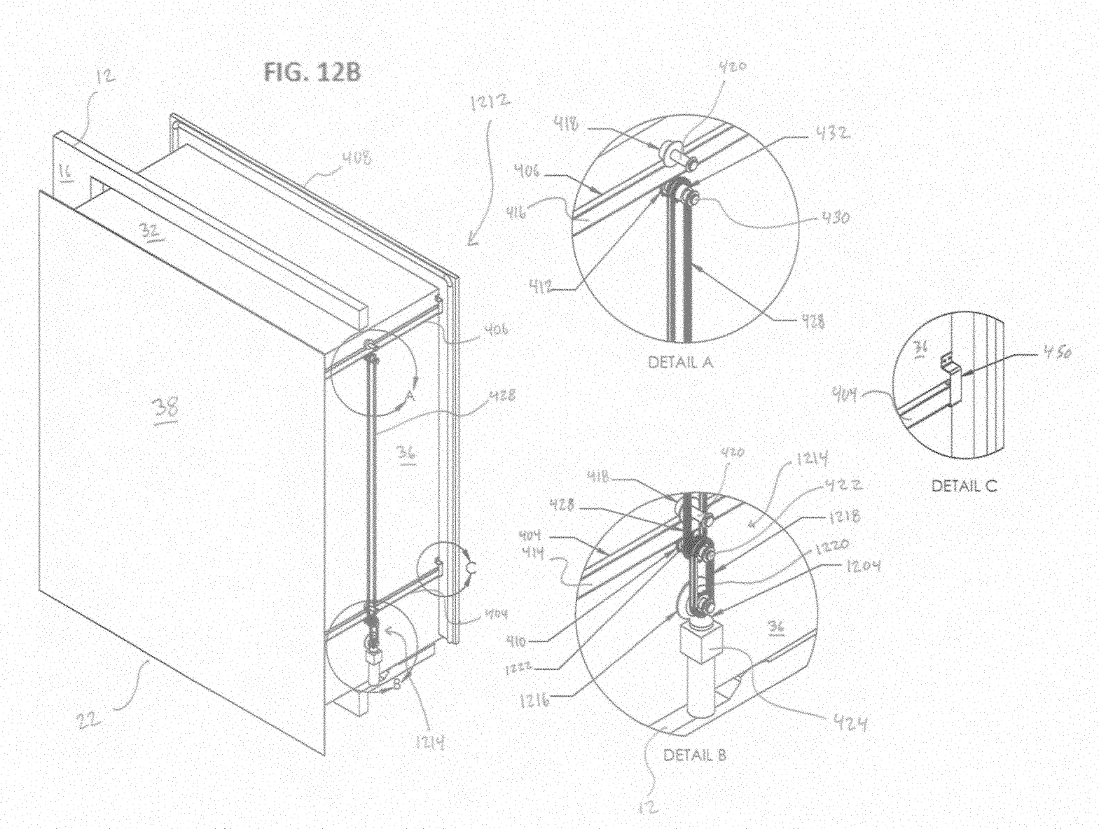

As mentioned above, some embodiments described herein may utilize multiple motors 424. For example, each of the corners A,B,C,D may have an actuator associated therewith as illustrated in the example embodiment of FIGS. 11A-11B. These example embodiments utilize multiple actuators on each side of the slide-out drive assembly, such as a pair of motors 1104. Here, utilizing multiple motors eliminates the need for mechanical timing components (e.g. timing belts, shafts, or bevel gear arrangements) to synchronize or time the upper and lower motors 1104. Instead, the motors 1104 may be synchronized using Hall Effect sensors as detailed above or using logic (e.g., a programmable logic controller). Also, while embodiments described herein illustrate just one or two of the motors, it will be appreciated that in some applications it may be beneficial to utilize two or more motors 424 that are synchronized (or controlled with feedback) to drive either or both of the drive chain assemblies 404,406.

FIG. 11A illustrates a right side slide-out drive assembly 1102 that includes two motors 1104, according to one or more embodiments. Here, each of the motors 1104 includes a gear box 1106 integrally attached and extending from a base 1108 of the motor 1104. As will be appreciated, the gear box 1106 is arranged to transfer a rotation force (torque) to a shaft such as the drive shafts 422,430. It will be appreciated that in some applications it may be beneficial to utilize two or more motors 424 that are synchronized (or controlled with feedback) to drive either or both of the drive chain assemblies 404,406.

FIG. 11B is an alternate embodiment of a right side slide-out drive assembly 1120, according to one or more embodiments. Here, the right side slide-out drive assembly 1120 includes a pair of motors 1130 oriented with their bases extending downward. Each of the motors 1130 includes a bevel gear 1132 extending from a top side of the motor 1130. Each of the bevel gears 1132 is oriented to rotate around a vertical axis (of its corresponding motor 1130) and drives a mating bevel gear 1134 that engages the slide-out room 22 (e.g., at the drive chain assembly 404). One of the mating bevel gears 1134 is disposed on each of the lower and upper drive shafts 422,430, and arranged thereon so that the bevel gears 1134 each rotate with their corresponding one of the drive shafts 422,430. Accordingly, a rotation of the bevel gear 1132 around the vertical axis drives the mating bevel gear 1134 engaged therewith, which, in turn, causes the corresponding one of the drive shafts 422,430 to rotate. The drive chain sprockets 410,412 rotate with the drive shafts 422,430 and actuate the drive chain assemblies 404,406 that are attached to the right sidewall 36 of the slide-out unit 22.

Also in this embodiment, the drive shafts 422,430 may extend from the right sidewall 36 of the slide-out room 22 rather than jamb assembly as previously described. In addition, a roller 1138 may be provided with a shaft 1140 that similarly secures it to the right sidewall 36 of the slide-out room 22. In these embodiments, it will be appreciated that the first bevel gears 1134 is attached to a portion of the vehicle body 12, for example, via a jamb assembly.

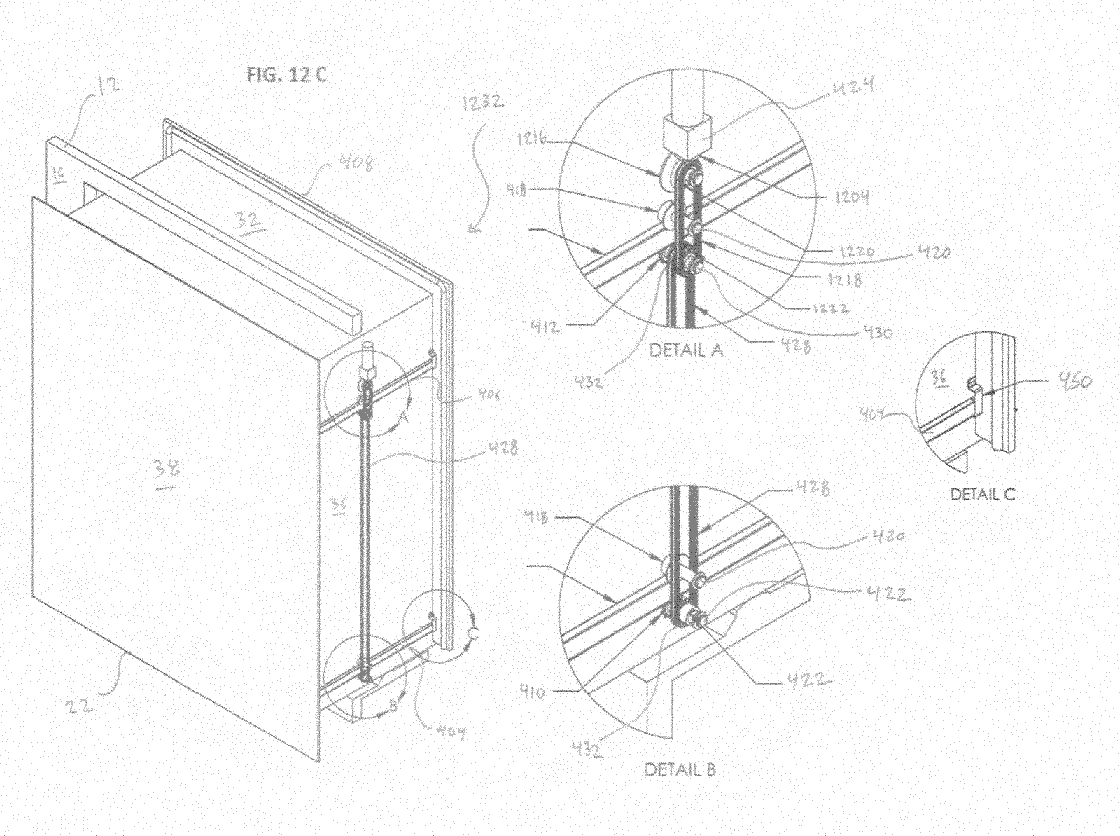

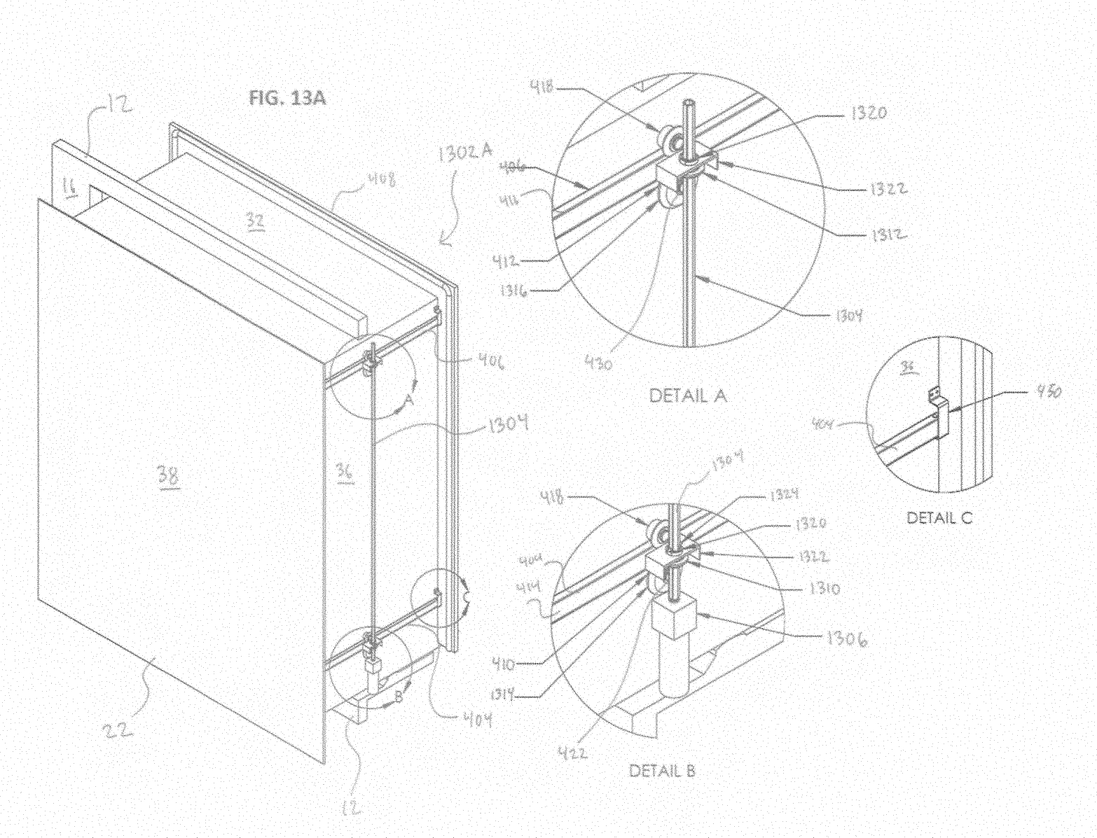

FIG. 12A illustrates an alternate embodiment of a right side slide-out drive assembly 1202, according to one or more embodiments. Here, the right side slide-out drive assembly 1202 is similar to the right side slide-out drive assembly 402b of FIG. 4, except that the motor 424 utilizes a gear box 1204′ having a first bevel gear 1204 that is arranged to engage and drive a second bevel gear 1206. The second bevel gear 1206 is arranged on the drive shaft 422 such that they rotate together. Accordingly, the motor 424 transmits rotational force to the (lower) drive shaft 422 via bevel gear arrangement of the bevel gears 1204,1206. Also, the (upper) drive shaft 430 rotates with the (lower) drive shaft 422 via the timing elements such as the timing belt 428.

FIG. 12B illustrates an alternate embodiment of a right side slide-out drive assembly 1212, according to one or more embodiments. Here, the right side slide-out drive assembly 1212 is similar to the right side slide-out drive assembly 1202 of FIG. 12A, except that the present right side slide-out drive assembly 1212 includes a drive extension assembly 1214 that permits the motor 424 and the bevel gear box 1204 attached thereto to be located further away from the drive shafts 422,430. Here, the drive extension assembly 1214 includes a bevel drive gear 1216 disposed proximate to the bevel gear box 1204 so as to be engaged and driven thereby. The bevel drive gear 1216 is secured within a jamb structure (not illustrated) but in other embodiments may be secured to the sidewall 36 of the slide-out room 22. The drive extension assembly 1214 also includes an extension drive chain 1218 that couples the bevel drive gear 1216 to the (lower) drive shaft 422 so that they rotate with each other in unison. Thus, the drive chain 1218 wraps around an extension drive sprocket 1220 that is attached to (and rotates with) the bevel drive gear 1216, and also wraps around a corresponding sprocket 1222 that is disposed on the (lower) drive shaft 422 at a location thereon proximate to the drive chain sprocket 410. As such, the drive shaft 422 includes a pair of sprockets (i.e., the drive chain sprocket 410 and the sprocket 1222) and is thus sometimes referred to as a double-sprocket configuration.

FIG. 12C illustrates an alternate embodiment of a right side slide-out drive assembly 1232, according to one or more embodiments. Here, the right side slide-out drive assembly 1232 is similar to the right side slide-out drive assembly 1212 of FIG. 12B, except that the motor 424 and the bevel gear box 1204 are instead oriented along the (upper) drive chain assembly 406 rather than along the (lower) drive chain assembly 404 as illustrated in FIG. 12B. Thus, the (upper) drive shaft 430 has the double-sprocket configuration in this embodiment because both the drive chain sprocket 412 and the sprocket 1222 that corresponds with the extension drive sprocket 1220 are disposed thereon.

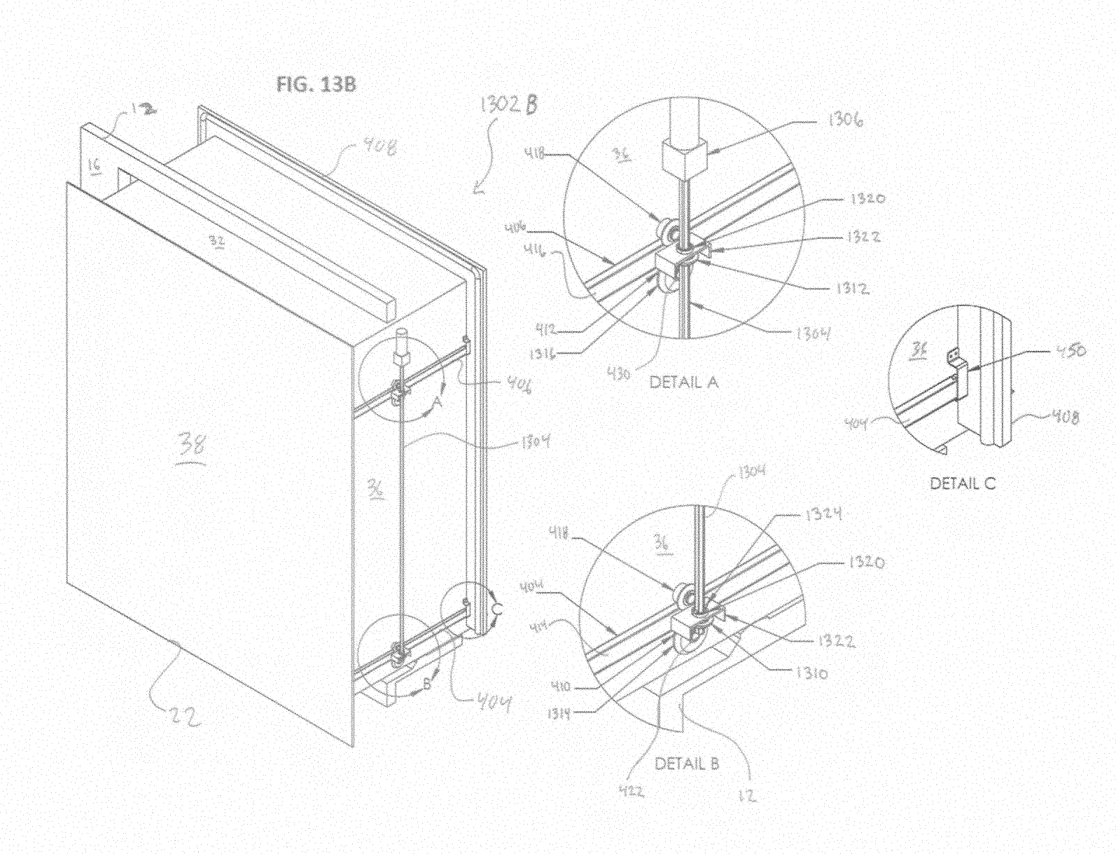

In other embodiments, timing elements are utilized other than belts and chains. FIGS. 13A-13B, for example, each illustrate an alternate embodiment of a right side slide-out drive assembly 1302A,B that utilize a timing shaft 1304 rather than a belt or chain such as the timing belt 428, according to one or more embodiments. Here, the timing shaft 1304 is operatively connected to the motor 1306. Also disposed on the timing shaft 1304 are a pair of bevel gears 1310,1312 that rotate with the timing shaft 1304. The bevel gears 1310,1312 are disposed at opposing ends of the timing shaft 1304, for example, at locations thereon that correspond with the drive chain assemblies 404,406. Here, the roller members 418 and the drive shafts 422,430 are secured directly into the right sidewall 36 of the right hand slide-out room assembly 1302A. In addition, each of the drive shafts 422,430 include a bevel gear 1314,1316 arranged thereon such that the bevel gear 1314 rotates with the (lower) drive shaft 422 and the bevel gear 1316 rotates with the (upper) drive shaft 430. The drive shafts 422,430 are disposed proximate to the drive chain assemblies 404,406, such that the motor 1306 rotates the timing shaft 1304, which in turn causes the pair of bevel gears 1310,1312 attached thereto to rotate with the timing shaft 1304; and each of the pair of bevel gears 1310,1312 engages and rotates its corresponding one of the bevel gears 1314,1316 such that the drive shafts 422,430 attached thereto rotate.

As illustrated in the example embodiment of FIG. 13A, the motor 1306 and the first bevel gear 1310 are disposed on the timing shaft 1304 proximate to the (lower) drive chain assembly 404 and the second bevel gear 1312 is disposed on the timing shaft 1304 proximate to the (upper) drive chain assembly 406. Similarly in the example embodiment illustrated in FIG. 13B, the motor 1306 and the first bevel gear 1310 are disposed on the timing shaft 1304 proximate to the (upper) drive chain assembly 406 and the second bevel gear 1312 is disposed on the timing shaft 1304 proximate to the (lower) drive chain assembly 404.

In these embodiments, a bushing 1320 and bushing bracket 1322 may be arranged on the timing shaft 1304 at locations thereon proximate to the first and second bevel gears 1310,1312 as a means of maintaining and/or securing the timing shaft 1304 in a position such that the bevel gear 1310 engages the bevel gear 1314 and so that the bevel gear 1312 engages the bevel gear 1316. The bushing 1320 may be secured to the timing shaft 1304 via a pin 1324 so that it rotates with the timing shaft 1304 within an aperature arranged to rotatably receive the timing shaft 1304. In some embodiments, the timing shaft 1304 is secured within a jamb assembly as previously described utilizing one or more of the busing brackets and, in such embodiments, the motor 1306 may also be provided on the same jamb assembly or elsewhere on the vehicle body 12.

An exemplary operation of an apparatus according to one embodiment of this disclosure will now be described with reference to FIG. 4, FIGS. 5A-5C, and FIGS. 6A-6C. When it is desired to move the slide-out room 22 from a first or retracted position as shown in FIG. 1 to a second or extended position as shown in FIG. 2, the actuator (e.g., the motor 424) is started, for example, by means of a switch (not shown), and is caused to turn in one direction. The motor 424 drives the drive shaft 422, which in turn causes the drive sprocket 410 to rotate. The timing belt 428 couples the (lower) drive shaft 422 to the (upper) drive shaft 430, so that they are “timed” and the (upper) drive shaft 430 rotates in unison with the (lower) drive shaft 422; and rotation of the (upper) drive shaft 430 in turn causes the (upper) drive sprocket 412 to rotate therewith. The lower and upper drive sprockets 410,412 are respectively engaged with a drive chain assembly 404,406 that is attached to the slide-out room 22. Accordingly, actuation of the motor 424 causes the drive sprockets 410,412 to rotate and drive the drive chain assemblies 404,406 engaged therewith such that the slide-out room 22 is translated along its path relative to and outward from the vehicle body 12. In an alternate embodiment (not shown), the motor 424 is not provided and the slide-out room 22 is only manually driven. In other embodiments, the vehicle 10 includes the slide-out compartment 30, which is driven either manually or via the motor 424 as detailed herein.

In even other embodiments, the slide-out drive assembly utilizes a belt or endless chain to actuate a plurality of drive cables attached to the sidewalls (the left and right sidewalls 34,36) of the slide-out room 22 in lieu of the above-described drive chain assemblies (i.e., drive chain assemblies 404,406,802). In one such embodiment, each side of the slide-out drive assembly includes four (4) drive cables extending therefrom and being connected to a corner of the left or right sidewall 34,36, such that there are eight (8) cables total that each connect to a corner of the left and the right sidewalls 34,36. More or less than eight (8)_drive cables 1402 may be utilized.

The slide-out drive assembly may include a pair of jambs, with a left jamb being associated with the left sidewall 34 and a right jamb being associated with the right sidewall 36. Here, each of the jambs includes an upper and lower sprocket on which a belt or chain rides such that the upper or lower sprocket rotate together in unison with the chain. Either of the upper or lower sprockets may be configured as a drive sprocket and coupled to a motor or other actuator such that torque is imparted thereon to drive the drive chain arranged thereon, and the other of the upper and lower sprocket may be configured as an idler sprocket.

As mentioned, in these embodiments, the slide-out drive assembly 1400 includes a plurality of the drive cables, and in one specific embodiment, the slide-out drive assembly includes eight (8) of the drive cables. The drive cables are secured at first ends thereof to the drive chain, for example, via cable-chain adjustment mechanism configured to permit adjustment of the drive cables with respect to the drive chain. Where eight (8) of the drive cables are utilized, four (4) of the drive cables may be utilized for pulling the slide-out room 22 out of the vehicle 10 (i.e., connected proximate to the rear frame 408 of the slide-out room 22) and the other four (4) cables may be utilized for pulling the slide-out room 22 into the vehicle 10 (i.e., connected proximate to the outside wall 38 of the slide-out room 22). Accordingly, four (4) of the drive cables may be arranged on each of the opposing left and right sidewalls 34,36, with each of the drive cables being secured at one of its ends to a corner of the slide-out room 22. Each of the drive cables then extends into its associated jamb member and arranged to wrap around a guide member or pulley disposed within the jamb, and connected at its second end to the drive chain. Thus, for example, when the drive chain rotates in one direction, it pulls the four (4) drive cables that are attached at the upper and lower corners of the sidewalls that are proximate to the front wall 14 of the slide-out room 22, and simultaneously takes up slack in the other four (4) drive cables that are attached at the upper and lower corners of the sidewalls that are proximate to the rear wall of the slide-out room 22. In these embodiments, a motor may be arranged in each of the jambs to drive one of the sprockets therein and engage the other sprocket therein via the drive chain that is also arranged therein; and in such embodiments, the motors in the opposing jambs may be synchronized or timed, for example, via a Hall effect sensor. In one embodiment, the drive sprockets in each jamb are coupled together via a connector shaft, where the connector shaft is a timing mechanism facilitating timing or synchronizing of the motors. In even other embodiments, the slide-out drive assembly includes a timing shaft or belt that synchronizes the rotation of the drive sprockets that are arranged in the opposing jambs. In some of these embodiments, a single motor may be provided within one of the jambs (i.e., the drive side jamb) to power the drive sprocket in the drive side jamb as well as the timing shaft or belt, and the timing shaft or belt in turn drives the drive sprocket arranged in the opposing jamb (i.e., the slave side jamb) such that the drive sprockets in the drive side jamb and the slave side jamb are synchronized, as will be appreciated by those skilled in the art. In even other embodiments, both the drive side jamb and the slave side jamb include a motor and their respective drive sprockets (and/or idler sprockets) are synchronized with a timing shaft or belt, as will be appreciated by those skilled in the art.

The present subject matter affords a simple and reliable slide-out drive assembly and/or mechanism for a slide-out unit such as a slide-out room 22 or slide-out compartment 26. This slide-out drive assembly and/or mechanism is simpler and more reliable than other slide-out drive systems that are presently known. The drive mechanism of the present subject matter assures that the slide-out unit will advance and retract smoothly and evenly, whether power is applied manually or with a motor. Because of the simplicity of the present drive mechanism, there is less that can go wrong than is the case with presently known slide-out operating systems.

Therefore, the disclosed systems and methods are well adapted to attain the ends and advantages mentioned as well as those that are inherent therein. The particular embodiments disclosed above are illustrative only, as the teachings of the present disclosure may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope of the present disclosure. The systems and methods illustratively disclosed herein may suitably be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the elements that it introduces. If there is any conflict in the usages of a word or term in this specification and one or more patent or other documents that may be incorporated herein by reference, the definitions that are consistent with this specification should be adopted.

Use of directional terms such as above, below, upper, lower, upward, downward, left, right, and the like are used in relation to the illustrative embodiments as they are depicted in the figures, the upward or upper direction being toward the top of the corresponding figure and the downward or lower direction being toward the bottom of the corresponding figure.

As used herein, the phrase “at least one of” preceding a series of items, with the terms “and” or “or” to separate any of the items, modifies the list as a whole, rather than each member of the list (i.e., each item). The phrase “at least one of” allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

What is claimed is:

1. A slidable room assembly in a vehicle body having a plurality of exterior walls, at least one of which has an opening, and a slide-out unit insertable within the opening and reciprocable between an extended position and a retracted position, the slide-out unit having a pair of opposing sidewalls, the slidable room assembly comprising:
a pair of first drive chains that are each respectively attached to the opposing sidewalls of the slide-out unit; and
a pair of jamb members that are each respectively arranged within the opening proximate to the opposing sidewalls of the slide-out unit, each of the jamb members includes:
a drive shaft arranged within a channel of the jamb member and a drive sprocket that is arranged on an end of the drive shaft and configured to engage one of the pair of first drive chains, wherein the drive sprockets rotate with the drive shafts to engage the pair of first drive chains and thereby move the slide-out unit between the extended position and the retracted position.

2. The slidable room assembly of claim 1, further comprising a motor coupled to one of the drive shafts.

3. The slidable room assembly of claim 3, further comprising a timing shaft that couples the drive shafts together, wherein a first of the drive shafts that is associated with a first of the opposing side walls of the slide-out unit rotates in unison with a second of the pair of drive shafts that is associated with a second of the opposing side walls of the slide-out unit.

4. The slidable room assembly of claim 1, wherein a first of the pair of jamb members includes a first motor coupled to a first of the pair of drive shafts, and wherein a second of the pair of jamb members includes a second motor coupled to a second of the pair of drive shafts.

5. The slidable room assembly of claim 4, further comprising a timing shaft that couples the drive shafts together such that they rotate in unison.

6. The slidable room assembly of claim 1, wherein each of the first drive chains is arranged within a channel member that is secured to each of the opposing sidewalls of the slide-out unit.

7. The slidable room assembly of claim 6, wherein each of the channel members includes a pair of channel member sidewalls and a rail that together define a chain channel, and wherein the first drive chain is arranged within the chain channel.

8. The slidable room assembly of claim 7, wherein each of the channel members further includes an interior channel defined by the channel member sidewalls and the rail, wherein the rail interposes the interior channel and the chain channel.

9. The slidable room assembly of claim 8, wherein each of the first drive chains includes a first chain end and a second chain end, the first chain end and the second chain end extending beyond a respective first rail end and second rail end of the chain rail when the first drive chains are arranged within the chain channel, and wherein the first chain end and the second chain end wrap around the first rail end and the second rail end, respectively, and extend into the interior channel of the channel member.

10. The slidable room assembly of claim 9, wherein the first chain end and the second chain end are each pinned within the interior channel of the channel member.

11. The slidable room assembly of claim 1, wherein the drive shaft of the first of the pair of jamb members is coupled to the drive shaft of the second of the pair of jamb members such that the drive shafts rotate together.

12. The slidable room assembly of claim 1, further comprising:
a pair of second drive chains that are each respectively attached to the opposing sidewalls of the slide-out unit, a first of the second pair of drive chains is spaced from a first of the first pair of drive chains on a first of the opposing sidewalls of the slide-out unit, and a second of the second pair of drive chains is spaced from a second of the second pair of drive chains on a second of the opposing sidewalls of the slide-out unit; and
each of jamb members includes a second drive shaft arranged within the channel of the jamb member and a second drive sprocket that is arranged on an end of the second drive shaft and configured to engage one of the pair of second drive chains, wherein the second drive sprockets rotate with the second drive shafts to engage the pair of second drive chains and thereby move the slide-out unit between the extended position and the retracted position.

13. The slidable room assembly of claim 12, wherein the pair of first drive chains and the pair of second drive chains are each arranged within a channel member that is secured to each of the opposing sidewalls of the slide-out unit.

14. The slidable room assembly of claim 13, wherein each of the channel members includes a pair of channel member sidewalls and a rail that together define a chain channel, and wherein the first drive chain and the second drive chain are arranged within the chain channel.

15. The slidable room assembly of claim 14, wherein each of the channel members further includes an interior channel defined by the channel member sidewalls and the rail, wherein the rail interposes the interior channel and the chain channel.

16. The slidable room assembly of claim 15, wherein each of the first drive chains and each of the second drive chains includes a first chain end and a second chain end, the first chain end and the second chain end extending beyond a respective first rail end and second rail end of the chain rail when the first drive chains and the second drive chains are arranged within the chain channel, and wherein the first chain end and the second chain end wrap around the first rail end and the second rail end, respectively, and extend into the interior channel of the channel member.

17. The slidable room assembly of claim 16, wherein the first chain end and the second chain end are each pinned within the interior channel of the channel member.

18. The slidable room assembly of claim 12, further comprising a timing assembly arranged within each of the pair of jamb members, wherein the timing assembly couples the first drive shaft to the second drive shaft such that that they rotate together.

19. The slidable room assembly of claim 18, wherein each of the timing assemblies comprises:
a first timing sprocket arranged on the first drive shaft;
a second timing sprocket arranged on the second drive shaft; and
a belt extending around and coupling the first and second timing sprockets such that the first drive shaft and the second drive shaft rotate together.

20. The slidable room assembly of claim 18, wherein each of the timing assemblies comprises:
a first bevel gear arranged on the first drive shaft;
a second bevel gear arranged on the second drive shaft; and
a timing shaft having a first and second mating bevel gear arranged thereon, the first mating bevel gear being arranged on the timing shaft to engage the first bevel gear and the second mating bevel gear being arranged on the timing shaft to engage the second bevel gear.
